(19) United States
(12) Patent Application Publication
(10) Pub. No.: US 2010/0138367 A1
(43) Pub. Date: Jun. 3, 2010

(54) SYSTEM, METHOD, AND PROGRAM FOR GENERATING NON-DETERMINISTIC FINITE AUTOMATON NOT INCLUDING e-TRANSITION

(76) Inventor: Nario Yamagaki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/452,987

(22) PCT Filed: Jul. 29, 2008
(86) PCT No.: PCT/JP2008/063604

§ 371 Date: Feb. 1, 2010

(30) Foreign Application Priority Data
Aug. 2, 2007 (JP) 2007-201510

(51) Int. Cl. G06F 15/18; G06N 5/02

(52) U.S. Cl. 706/12; 706/50

(57) ABSTRACT

An initial setting unit receives from an input device a syntax tree generated from a regular expression, and initializes an NFA and an NFA converting section that applies five conversion patterns to each node of the syntax tree to directly convert the node into an NFA not including ε-transition. When the conversion is finished, the NFA converting section outputs the NFA generated to an output device.

### RELATED APPLICATION

The present application claims priority rights based on the Japanese Patent Application 2007-201510, filed in Japan on Aug. 2, 2007. The total disclosure of the Patent Application of the senior filing date is to be incorporated herein by reference.

### TECHNICAL FIELD

This invention relates to a system and a method for generating a non-deterministic finite automaton not including ε-transition, and to a storage medium having recorded thereon a program for generating a non-deterministic finite automaton not including ε-transition. More particularly, this invention relates to a system, a method and a program for generating a non-deterministic finite automaton, not including ε-transition, in which the non-deterministic finite automaton, not including ε-transition, may directly be generated without removing the ε-transition.

### BACKGROUND ART

Recently, to perform string matching (pattern matching) at a high speed, such a technique of configuring an NFA (Non-deterministic Finite Automaton) directly as a hardware circuit and constructing the NFA circuit on a reconfigurable device, such as an FGPA (Field-Programmable Gate Array), as disclosed in, for example, Non-Patent Document 1.

With the pattern matching by the hardware, the NFA that represents a pattern of a subject for search and that is specified as a regular expression, is generated, and directly configured as a circuit to provide for high-speed processing that takes advantage of parallel processing.

On the other hand, in an NFA circuit disclosed in, for example, Non-Patent Document 1, only one character (1 byte) may be processed per clock cycle. Hence, the search throughput depends on the operation frequency. The search throughput T[Mbps] may be calculated by T=8×K×M, where M is an operation frequency [MHz] and K is a number of bytes processed per clock cycle.

In Non-Patent Documents 2 and 3, and the Patent Document 1, for example, several techniques of generating an NFA have been proposed in which the condition for state transition has been extended to a plurality of characters (bytes) and implementing the so generated NFA in a circuit. By so doing, the number of characters (number of bytes) that can be processed per clock cycle may be increased to improve the search throughput.

In general, the conversion of a regular expression into an NFA may be divided into
conversion of the regular expression into a syntax tree (Syntax Tree), and
conversion of the syntax tree into the NFA. See page 327 of Non-Patent Document 4, for example.

The conversion from the regular expression to an NFA may be achieved by recursively applying four basic conversion patterns to respective nodes of the syntax tree, provided that, in the syntax tree, the node indicating the concatenation is ‘•’.

These four basic conversion patterns are shown in FIGS. 27 to 30.

FIG. 27 shows the basic conversion pattern applied to a case where the node of the syntax tree is a character c.

FIG. 28 shows the basic conversion pattern applied to a case where the node of the syntax tree is ‘|’ (metacharacter meaning OR).

FIG. 29 shows the basic conversion pattern applied to a case where the node of the syntax tree is ‘•’ (concatenation).

FIG. 30 shows the basic conversion pattern applied to a case where the node of the syntax tree is ‘*’ (metacharacter indicating a zero time of match or indicating one or more times of match).

In FIGS. 27 to 30, N₁ and N₂ denote regular expressions, a state I denotes an initial state, a state F denotes a final state and ε denotes ε-transition (epsilon transition).

This ε-transition is a special transition capable of transitioning without waiting for an input.

There exist ε-transitions in an NFA generated using the four basic conversion patterns of FIGS. 27 to 30. An NFA containing ε-transitions is referred to below as ‘ε-NFA’ for distinction from NFA not including ε-transition.

The regular expression having metacharacters other than those shown above may usually be rewritten to a regular expression that uses these four basic conversion patterns. It is therefore necessary to perform the rewrite operation in a stage before generating the syntax tree.

For example, “N₁?” indicating a zero time of match or only one time of match may be rewritten to “(N₁|)”, whilst “N₁+” indicating one or more times of match may be rewritten to “N₁N₁*”.

In the above mentioned pattern matching circuit by hardware, each state of the NFA is implemented by a flip-flop, and hence a clock supplied to the flip-flop serves as a trigger for processing in the circuit. It is therefore not possible to implement ε-transition that is able to transition without waiting for an input. That is, in generating an NFA embedded in hardware, it is necessary to
convert a regular expression to a syntax tree, and
remove ε-transition from the s-NFA converted from the syntax tree.

This processing for removing ε-transition is termed ε-closure. For example, the ε-closure of a state q denotes a set of all of states that may be reached from q via only the ε-transition.

With the length (number of characters) n of a regular expression, the processing of O(n) is needed to convert a syntax tree into an ε-NFA. It has been known that, to perform ε-closure of an ε-NFA with the number of states n, the processing of O(n³) is needed (Non-Patent Document 5).

### Patent Document 1:

JP Patent Kokai Publication No. JP2007-142767A

### Non-Patent Document 1:

Reetinder Sidhu and Viktor K. Prasanna, Proceedings of the 9th Annual IEEE Symposium on Field-Programmable Custom Computing Machines), 2001, pages 227 to 238

### Non-Patent Document 2:

Christopher R. Clark and David E. Schimmel, Proceedings of the 12th Annual IEEE Symposium on Field-Programmable Custom Computing Machines, 2004, pages 249 to 257

### Non-Patent Document 3:

Norio Yamagaki, Kiyohisa Ichino and Satoshi Kamiya, Proceedings of the 2007 IEICE General Conference, 2007, D-18-2 (page 188)

### Non-Patent Document 4:

Kasetu Kondoh, Algorithm and Data Structure for C-Programmers, Softbank Publishing, 1998, pages 297 to 330

### Non-Patent Document 5:

(translators: Akihiro Nozaki, Masako Takahashi, Motoshi Machida and Hideki Yamazaki) John E. Hoperoft, Rajeeb Motowani and Jeffrey D. Ullman, Information & Computing-3 Automaton, Language and Computation I, Second Edition, Science Company, 2003, 80 to 90, 111 to 116, pages 168 to 171

### DISCLOSURE OF THE INVENTION

### Problems to be Solved by the Invention

The disclosures of the above mentioned Patent Document 1 and the Non-Patent Documents are to be incorporated by reference herein. The following is an analysis by the present inventors.

In pattern matching with an NFA directly incorporated in hardware, the following problem arises in a method of converting a syntax tree generated from the regular expression to an NFA free of ε-transition. It is noted that a phrase which reads: “being free from ε-transition” means that there is no general processing related with ε-transition. In the present application, this phrase is indicated by an expression “not including ε-transition”.

A first problem is that conversion from the regular expression to an NFA not including ε-transition is time-consuming. If the NFA not including ε-transition for incorporation into the hardware is to be generated by a conventional technique of
generating an ε-NFA from a syntax tree; and
calculating the ε-closure of the ε-NFA, much processing time is taken in generating the NFA. The processing time becomes longer the more the number of the regular expressions, that is, the more the number of the patterns to be searched. The reason is that, with the length (number of characters) n of a regular expression, the time complexity of O(n³) is needed in calculating the ε-closure of ε-NFA.

A second problem is that, in converting a regular expression of interest into an NFA, it is necessary to rewrite the regular expression of interest into a regular expression containing characters and only metacharacters ‘|’ indicating OR and ‘*’ indicating zero time of match or indicating one or more times of match, at the outset, and to convert the resulting regular expression into a syntax tree in which a symbol ‘•’ for concatenation and a symbol ‘Φ’ representing empty are additionally provided as nodes. It is assumed that N is any regular expression. It should be noted that the symbol indicating emptiness used in such a manner that, when a regular expression “N?” is rewritten to another regular expression that uses a metacharacter the resulting regular expression is “(N|Φ)” (N or empty).

The reason is that, since the basic conversion patterns of ε-NFA, recursively applied to each node of the syntax tree, are the four patterns shown in FIGS. 27 to 30, it is necessary to convert the regular expression to a form that allows for application of these four basic conversion patterns.

On the other hand, if the regular expression “N+”, out of the metacharacters indicated in connection with the second problem, is rewritten at the outset to “NN*” and converted into a syntax tree, which syntax tree is further converted into NFA, the NFA, representing the regular expression N, appears twice. The NFA representing the regular expression N is therefore redundant and the number of the states increases, thus presenting a third problem.

It is therefore an object of the present invention to provide a system, a method and a program for generating an NFA whereby the conversion from a regular expression to an NFA not including ε-transition may be performed at a high speed.

It is another object of the present invention to provide a system, a method and a program for generating an NFA whereby, in case a regular expression containing ‘?’ (zero time of match or only one time of match) and ‘+’ (one or more times of match), out of the metacharacters that are in need of rewriting at the outset, are to be converted to a syntax tree, it is unnecessary to rewrite the metacharacters.

It is yet another object of the present invention to provide a system, a method and a program for generating an NFA whereby the number of redundant states is not increased for a regular expression that uses a metacharacter ‘+’ (one or more times of match).

### Means to Solve the Problems

In the system for generating an NFA not including ε-transition, according to the present invention, an NFA not including ε-transition is directly generated from a regular expression represented by a syntax tree.

A system according to the present invention includes a syntax tree storage unit that stores a data structure indicating the structure of a syntax tree. This syntax tree is generated from a regular expression represented by only the character and two kinds of metacharacters indicating selection and indicating zero time of match or indicating one or more times of match (‘|’ and ‘*’), and additionally has nodes of a symbol ‘•’ for concatenation and a symbol ‘Φ’ representing empty.

The system according to the present invention also includes:

an initial setting means for initializing an NFA, not including ε-transition, generated on discriminating the type of a root node of the syntax tree;

an NFA storage unit that stores a data structure indicating an NFA configuration; and

an NFA converting means, which NFA converting means performs the processing for conversion on each node of the syntax tree, that is, the processing for applying a conversion pattern to an NFA not including ε-transition to each node, to generate an NFA not including ε-transition.

The first object of the present invention may be accomplished by employing this configuration and performing the processing for conversion for the character, metacharacters (‘|’ and ‘*’), a symbol indicating concatenation ‘•’ and a symbol representing empty ‘Φ’, on the nodes of the input syntax tree.

Another system according to the present invention includes

a syntax tree storage unit that stores a data structure indicating the construction of a syntax tree, which is generated from a regular expression specified by using a character and only four kinds of metacharacters (‘|’, ‘?’, ‘+’ and ‘*’) indicating selection, zero time or only one time of match, one or more times of match, and indicating zero time of match or indicating one or more times of match, respectively. The syntax tree additionally has ‘•’ indicating concatenation as a node.

The System Also Includes:

an initial setting means that initializes an NFA, not including ε-transition, generated on discriminating the type of a root node of the syntax node;

an NFA storage unit that stores a data structure representing the NFA configuration;

an NFA converting means, which performs the processing for conversion on each node of the syntax tree to generate an NFA not including ε-transition.

The above mentioned objects of the present invention may be accomplished by using the above described configuration and by performing the processing for conversion on respective nodes of the input syntax tree. The processing for conversion is performed on the character or on the four kinds of metacharacters (‘|’, ‘?’, ‘+’ and ‘*’) for selection, for zero time or only one time of match, for one or more times of match and for zero time of match or for one or more times of match, in each node of the input syntax tree. This processing for conversion is the processing of applying the pattern for conversion into an NFA not including ε-transition to each node.

### EFFECT OF THE INVENTION

According to the present invention, it is possible to perform the conversion from the regular expression to an NFA not including ε-transition at a high speed.

According to the present invention, it is unnecessary to rewrite metacharacters ‘?’ (zero time of match or only one time of match) and ‘+’ (one or more times of match) in the regular expression in converting the regular expression to an NFA.

According to the present invention, it is possible to suppress that the number of redundant states is increased in an NFA representing a regular expression that uses the metacharacter ‘+’ (one or more times of match).

### BRIEF DESCRIPTION OF THE DRAWINGS

FIG. 1 is a block diagram showing a configuration of Example 1 of the present invention.

FIG. 2 is a flowchart for illustrating the operation of Example 1 of the present invention.

FIG. 3 is a schematic view showing an instance of a syntax tree converted from the regular expression “ab*(c|d)e?f(gh)+i”.

FIG. 4 is a schematic view showing an instance of a data structure of an NFA.

FIG. 5 is a flowchart showing a step A4 in FIG. 2.

FIG. 6 is a flowchart showing a step B3 in FIG. 5.

FIG. 7 is a flowchart showing a step B5 in FIG. 5.

FIG. 8 is a schematic view showing a conversion pattern to the NFA for “N₁N₂” generated in a step B5 in FIG. 5, where N₁ and N₂ are regular expressions.

FIG. 9 is a flowchart showing a step B7 in FIG. 5.

FIG. 10 is a schematic view showing a conversion pattern to the NFA for “N₁|N₂” generated in a step B7 in FIG. 5, where N₁ and N₂ are regular expressions.

FIG. 11 is a flowchart showing a step B9 in FIG. 5.

FIG. 12 is a schematic view showing a conversion pattern to the NFA for “N₁*” generated in a step B9 in FIG. 5, where N₁ is a regular expression.

FIG. 13 is a flowchart showing a step B11 in FIG. 5.

FIG. 14 is a schematic view showing a conversion pattern to the NFA for “(N₁|Φ)” generated in a step B11 in FIG. 5, where N₁ denotes a regular expression and Φ denotes empty.

FIG. 15 is a schematic view showing an NFA, not including ε-transition, for the regular expression “ab*(c|d)e?f(gh)+i” generated in accordance with the present exemplary embodiment.

FIG. 16 is a block diagram showing the configuration of the second exemplary embodiment of the present invention.

FIG. 17 is a flowchart showing the operation of the second exemplary embodiment of the present invention.

FIG. 18 is a schematic view showing an instance of a syntax tree converted from the regular expression “ab*(c|d)e?f(gh)+i”.

FIG. 19 is a flowchart showing a step A6 in FIG. 17.

FIG. 20 is a flowchart showing a step B14 in FIG. 19.

FIG. 21 is a flowchart showing a step B16 in FIG. 19.

FIG. 22 is a schematic view showing a conversion pattern to the NFA for “(N₁+)” generated in a step B16 in FIG. 19, where N₁ denotes a regular expression.

FIG. 23 is a schematic view showing an NFA, not including ε-transition, for the regular expression “ab*(c|d)e?f(gh)+i” generated in accordance with the present exemplary embodiment.

FIG. 24 is a block diagram showing the configuration of the third exemplary embodiment of the present invention.

FIG. 25 is a flowchart showing the operation of the third exemplary embodiment of the present invention.

FIG. 26 is a block diagram showing the configuration of the fourth exemplary embodiment of the present invention.

FIG. 27 is a schematic view showing a conversion pattern for the ε-NFA for a character c.

FIG. 28 is a schematic view showing a conversion pattern for the ε-NFA for a regular expression “N₁|N₂”, where N₁ and N₂ are regular expressions.

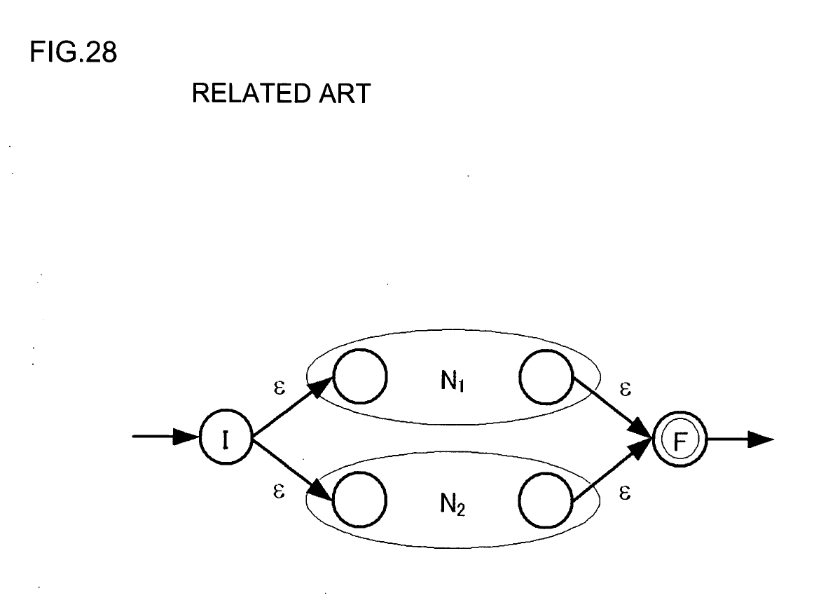

FIG. 29 is a schematic view showing a conversion pattern for the ε-NFA for a regular expression “N₁|N₂”, where N₁ and N₂ are regular expressions.

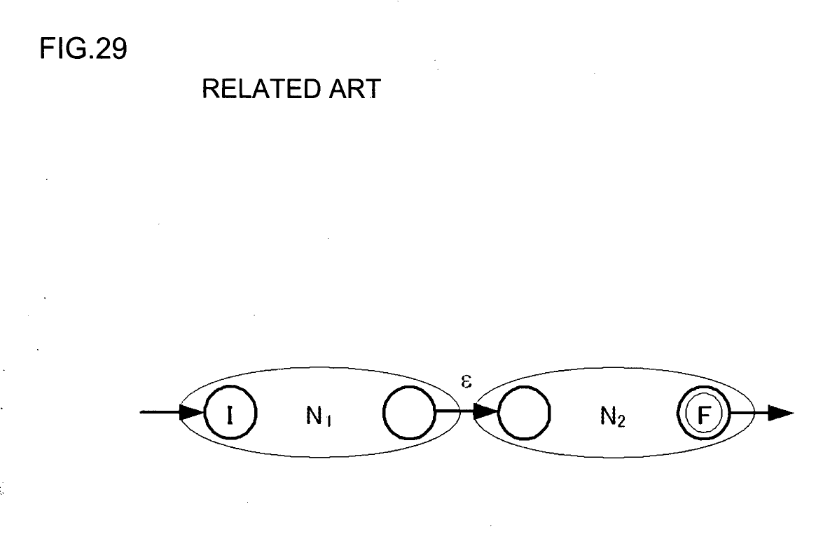

FIG. 30 is a schematic view showing a conversion pattern for the ε-NFA for a regular expression “N₁*”, where N₁ is a regular expression.

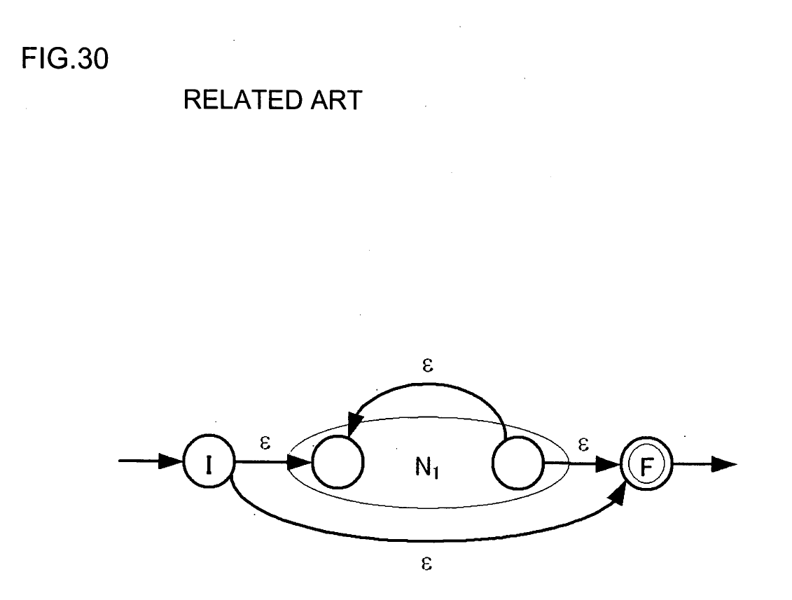

### EXPLANATIONS OF SYMBOLS

1 input device
2 data processing device
3 storage unit
4 output device
5 data processing device
6 data processing device
7 data processing device
8 program for conversion into NFA
21 initial setting means
22 NFA converting means
23 initial setting means
24 NFA converting means
25 syntax tree converting means
31 syntax tree storage unit
32 NFA storage unit

### PREFERRED MODES FOR CARRYING OUT THE INVENTION

Referring to the drawings, preferred exemplary embodiments of the present invention will be described in detail.

### First Exemplary Embodiment

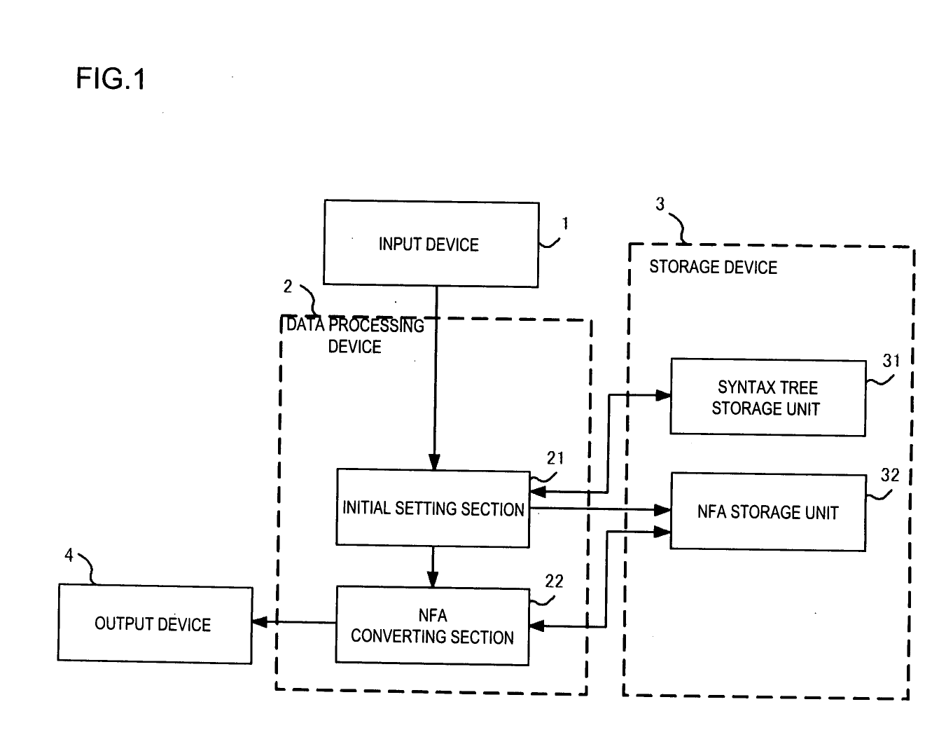

FIG. 1 is a block diagram showing the configuration of a first exemplary embodiment of the present invention. Referring to FIG. 1, the first exemplary embodiment of the present invention includes an input device 1, such as a keyboard, a data processing device 2 that is operated under program control, a storage device 3 for information storage, and an output device 4, such as a display or a printer.

The storage device 3 is constructed by a memory (storage medium), such as a read-write memory or a hard disc, The storage device 3 includes a syntax tree storage unit 31 and an NFA storage unit 32, for one object, which is to be stored, to another.

The syntax tree storage unit 31 stores and holds a syntax tree of a regular expression which is supplied from the input device 1 to an initial setting means 21, by a data structure having a list type structure.

An NFA converted by the initial setting means 21 and an NFA converting means 22 from a syntax tree of interest, stored in the syntax tree storage unit 31, is stored in the NFA storage unit 32 in a data structure, such as a list type structure or a matrix form.

The data processing device 2 includes the initial setting means 21 and the NFA converting means 22. The ‘means’ herein denotes respective processing functions.

The initial setting means 21 reads in the regular expression, delivered from the input device 1, and which has been converted into the form of a syntax tree. The initial setting means 21 then causes the so read regular expression to be stored in the syntax tree storage unit 31. The initial setting means 21 initializes the NFA generated depending on the types of the root node, that is, on whether the root node is a character, a particular metacharacter or a symbol ‘•’ that stands for concatenation. The initial setting means 21 then causes the data structure of the so initialized NFA to be stored in the NFA storage unit 32.

The NFA converting means 22 receives a data structure, representing the syntax tree, from the initial setting means 21. The NFA converting means 22 also reads in the data structure, representing the NFA, from the NFA storage unit 32, and applies a pattern for conversion into the NFA not including ε-transition to respective nodes of the syntax tree received from the initial setting means 21 for converting the syntax tree into the NFA not including ε-transition. In the present exemplary embodiment, the phrase “not including ε-transition” again means not including routine processing related with ε-transition.

When the conversion has been finished, the NFA converting means 22 causes the data structure, representing the NFA, to be stored in the NFA storage unit 32, while outputting the resulting data structure to the output device 4.

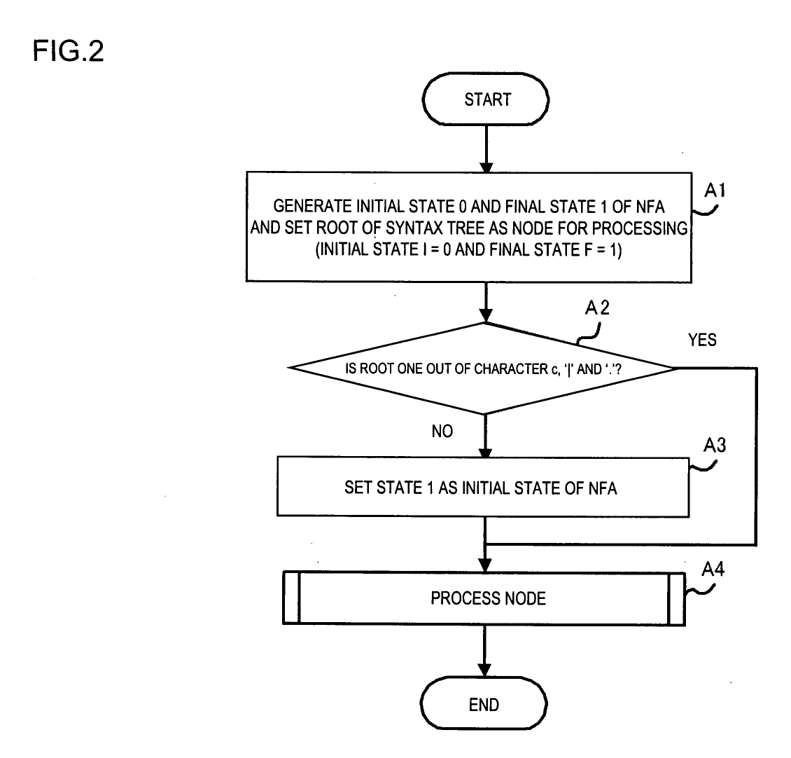

Referring to the block diagram of FIG. 1 and the flowcharts of FIG. 2, the operation of the first exemplary embodiment of the present invention will be described in detail.

The regular expression, delivered from the input device 1, and which has been expressed as a syntax tree, is delivered to the initial setting means 21.

It is assumed that the input regular expression has been re-written beforehand to a regular expression that uses only two kinds of metacharacters, that is, selection ‘|’ (OR) and ‘*’ (for zero time of match or for one or more times of match) and is in the form of a syntax tree. It is also assumed that a node ‘•’ representing the concatenation and a node ‘Φ’ representing empty are also additionally provided in this syntax tree.

The data structure of the syntax tree also has

the type of each node (whether the node is a character, one of the above mentioned two metacharacters, a symbol ‘•’ representing the concatenation or a symbol ‘Φ’ representing empty),

a list to a left child node, and

a list to a right child node (if there is only one child node, management is unified to only the left or right child node). The syntax tree is of a well-known data structure and hence is not described in detail.

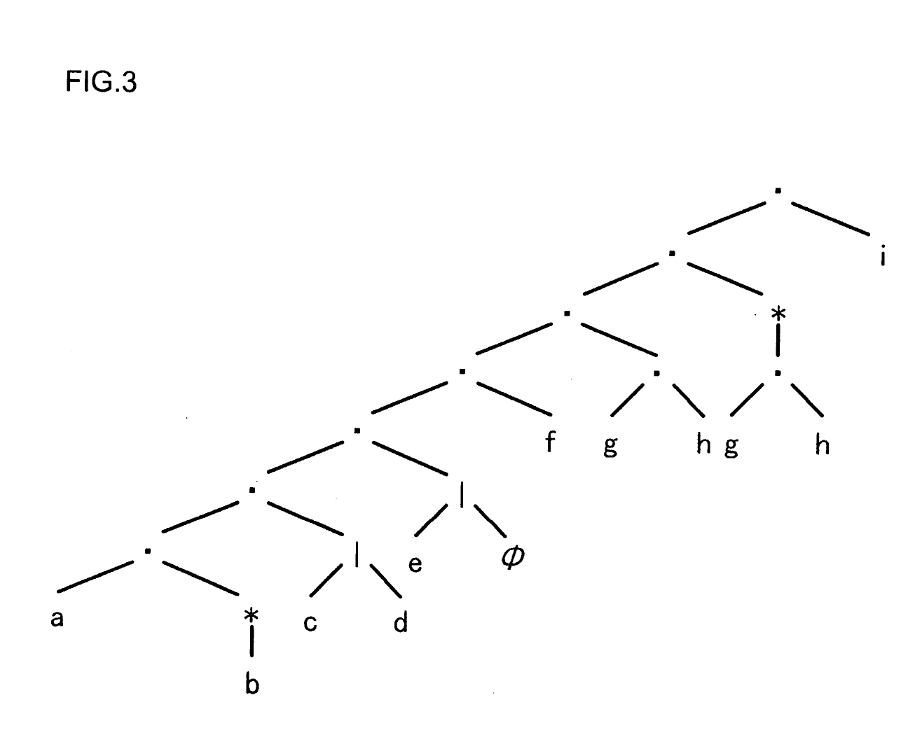

FIG. 3 schematically shows a syntax tree in case the regular expression for a subject is:

“ab*(c|d)eMgh)+i”. In this case, the regular expression is re-written into another regular expression that uses only metacharacters ‘|’ and ‘*’:
“ab*(c|d)(e|)f(gh)(gh)*i”, and is then converted into a syntax tree shown in FIG. 3, using a symbol ‘•’ indicating concatenation and a symbol ‘Φ’ representing empty.

On receipt of the syntax tree data, the initial setting means 21 causes the data structure, representing the syntax tree, to be stored in the syntax tree storage unit 31. The initial setting means 21 also generates a state 0 and a state 1, and sets the states 0 and 1 so as to be the initial state and the final state of the NFA, respectively (step A1).

The initial setting means 21 sets the root node of the input syntax tree so as to be the node for processing, while setting an initial state I and a final state F so as to be a state 0 and a state 1, respectively (step A1).

It is checked whether or not the root node corresponds to any one of a character, a metacharacter ‘|’ and a symbol for concatenation ‘•’ (step A2).

If the root node corresponds to none of these, the state 1 is set so as to be the initial state of the post-conversion NFA (step A3) as well. In this case, the state 1 is the initial state and is also the final state of the post-conversion NFA.

On completion of the above processing (steps A1, A2 and A3), the initial setting means 21 causes the NFA generated to be stored in the NFA storage unit 32. The initial setting means 21 reads in syntax tree data from the syntax tree storage unit 31. The initial setting 21 means supplies the so read syntax tree data and the processing end signal to the NFA converting means 22.

It should be noted that the NFA stored by the initial setting means 21 in the NFA storage unit 32 has

a state number of a source of transition (state ID),

a state number of a destination of transition (state ID) and

a character that is to become a condition for transition. That is, the NFA has a data structure in which, with attention directed to a certain state, there is generated the state of the source of transition that transitions to the state of interest.

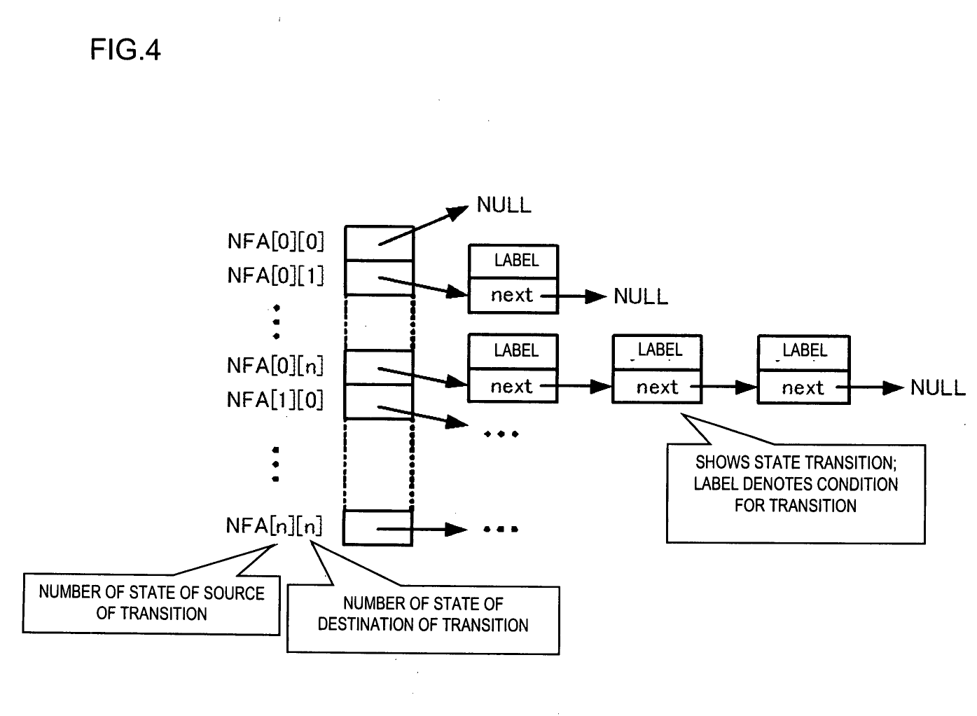

The NFA is implemented by a data structure linked to a two-dimensional array (Linked List) as shown for example in FIG. 4. With the two-dimensional array NFA[i][j] (i, j=0 to n), pointers for a transition between two arbitrary states are stored by transition source state numbers (indexes i) and by transition destination state numbers (indexes j), respectively

The transition includes a label (a character that becomes a condition for transition) and a pointer to the next transition (next).

The NFA may also be expressed by a matrix form, in which case a row number i and a column number j denote a state number of the source of transition and a state number of the destination of transition, respectively. Also, a character is entered that stands for the condition of transition from a state i to a state j for each element. For example, if there is a plurality of conditions from a certain state to another, particular definitions are required, such as by using ‘+’. For example, characters ‘a’ and ‘b’ being the conditions for transition may be expressed by “a+b”. If there is no transition, it may be expressed by ‘0’.

Then, on receipt of the signal for end of processing and syntax tree data from the initial setting means 21, the NFA converting means 22 reads in initialized NFA data from the NFA storage unit 32 and performs the processing for node conversion from the root node which is the node for processing (step A4).

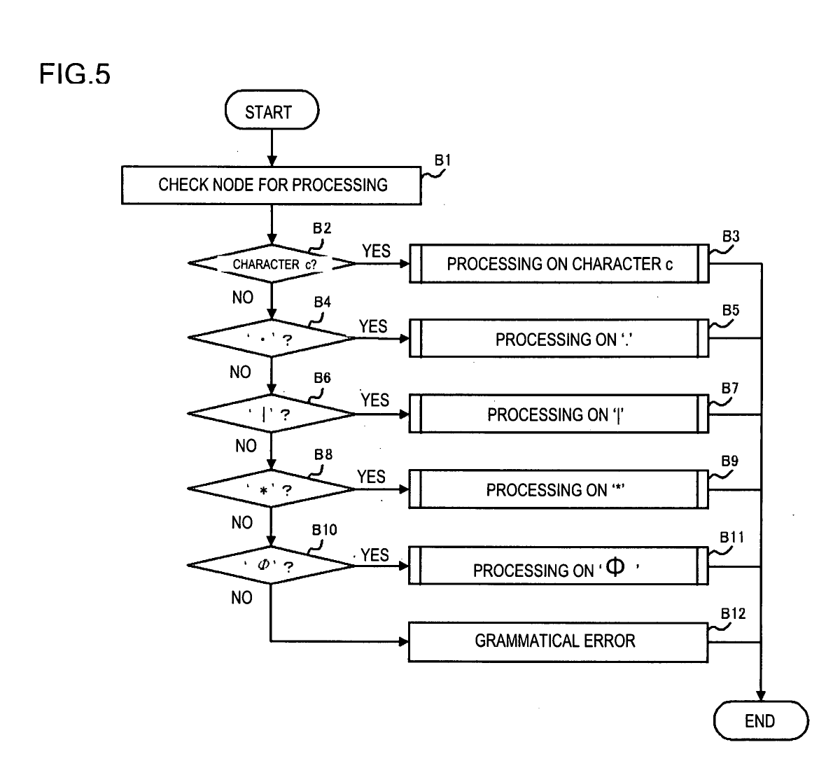

FIG. 5 is a flowchart for illustrating a more detailed operation of the step A4. The NFA converting means 22 checks the root node as the initial node for processing (step B1).

If the root node is a character, the NFA converting means 22 performs the processing for the character (steps B2 and B3).

If the root node is a symbol for concatenation ‘•’, the NFA converting means 22 performs the processing for ‘•’ (steps B4 and B5).

If the root node is a metacharacter ‘|’ for selection (OR), the NFA converting means 22 performs the processing for ‘|’ (steps B6 and B7).

If the root node is a metacharacter ‘*’ for zero time of match or for one or more times of match, the NFA converting means 22 performs the processing for ‘*’ (steps B8 and B9).

If the root node is a metacharacter ‘Φ’ representing empty, the NFA converting means 22 performs the processing for ‘Φ’ (steps B10 and B11).

If none of the above is valid, the NFA converting means 22 decides that a syntax error has occurred and performs the processing for error for the regular expression in question (step B12) to terminate the processing for the step A4.

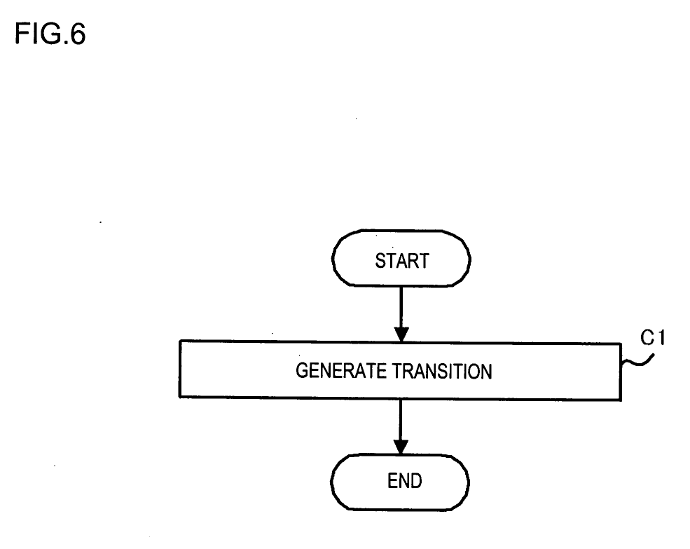

FIG. 6 is a flowchart for illustrating a more detailed operation for the step B3 of FIG. 5. The NFA converting means 22 checks the current node for processing. If the node is a character c, the NFA converting means 22 generates a transition for the label c from the currently set initial state I to the final state F (step CO to terminate the processing for the character c (step B3).

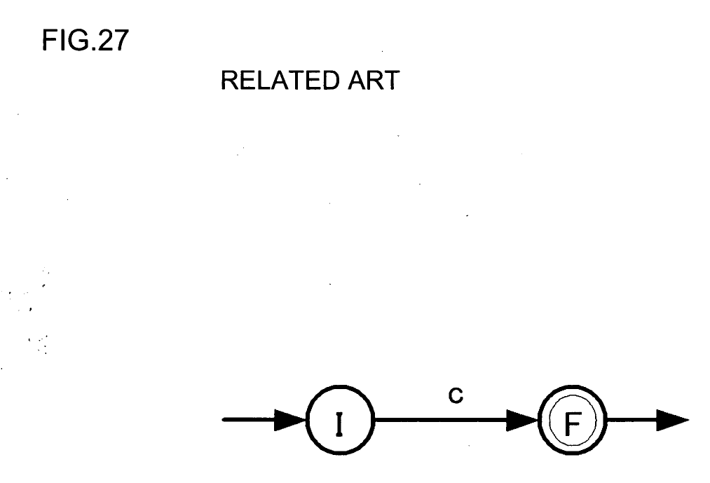

In case the input character is c, the transition for the label c means transition from the state I to the state F. In this case, the NFA not including ε-transition, generated between the initial state I and the final state F by the step B3, is similar to that shown in FIG. 27. This is defined as a conversion pattern for the character c (step B3).

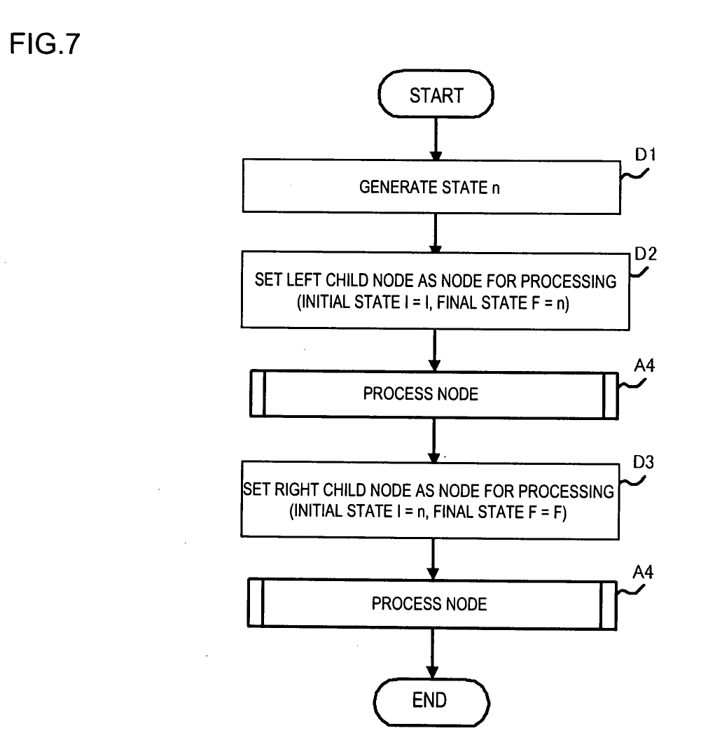

FIG. 7 is a flowchart illustrating a more detailed operation of the step B5 of FIG. 5. The NFA converting means 22 checks the current node for processing and, if the node is a symbol ‘•’ that stands for concatenation, the NFA converting means 22 generates a new state n (step D1), where n stands for an ID that specifies a state. There is no limitation to the setting of the state ID except if the state ID thus set is the same as a pre-existing state ID.

In the present exemplary embodiment, the initial setting means 21 has already generated the initial state 0 and the final state 1 for the NFA in its entirety. Hence, the states of serial numbers are newly generated such as a state 2 and a state 3.

The state I set before processing the step B5 is set as the initial state I, and the state n generated in the step D1 is set as the final state F (step D2).

If the node for processing is ‘•’, it necessarily has child nodes on the left and right sides. Hence, the left child node of the node for processing in question is newly taken to be a node for processing (step D2) and the processing for node conversion is performed thereon (step A4).

When the processing for conversion for the left child node has been finished, the state n, generated by the step D1, is set as an initial node I, and the state F, set before start the processing for the node ‘•’, which is the node for processing in question, is set as the final state F. A right child node is now taken to be a new node for processing (step D3) and the processing for node conversion is performed thereon (step A4).

When the processing to effect conversion for the right child node has been finished, the processing for the node ‘•’ (step B5) comes to a close.

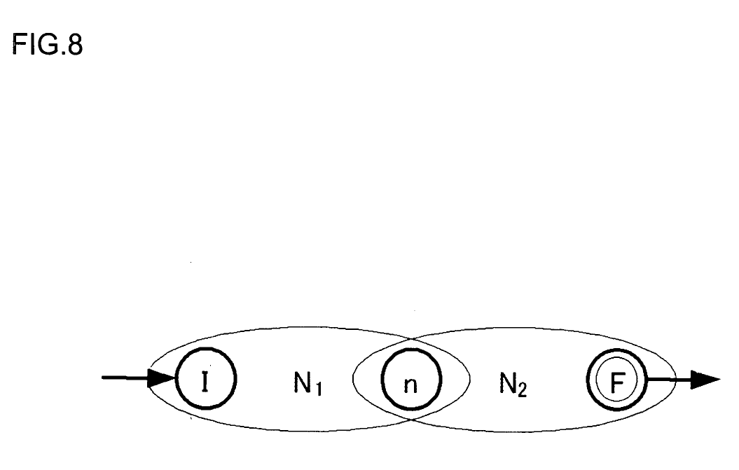

FIG. 8 shows a conversion pattern to the NFA not including ε-conversion, which is applied to the initial state I, the final state F and the node ‘•’. In FIG. 8, N₁ denotes a regular expression represented by a syntax tree having a left child node of the node ‘•’ as a root, and N₂ denotes a regular expression represented by a syntax tree having a right child node of the node ‘•’ as a root.

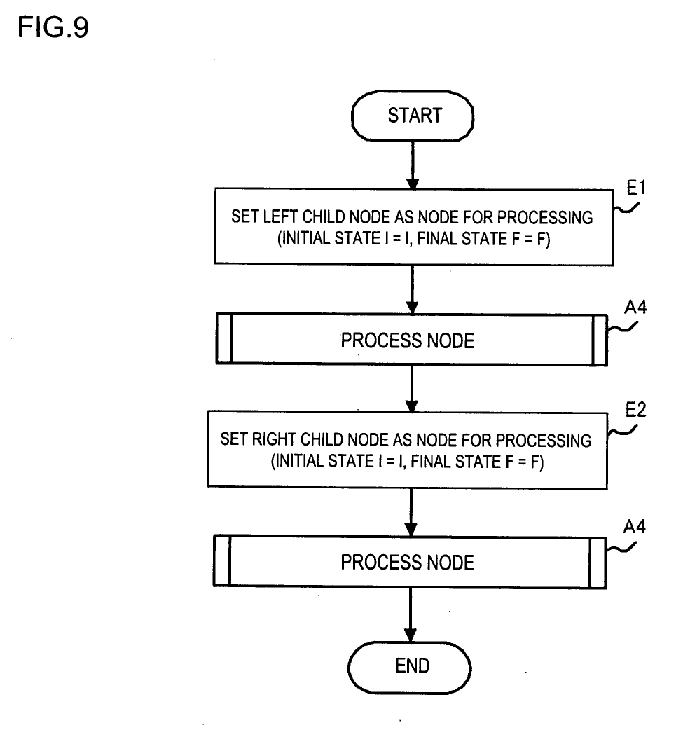

FIG. 9 is a flowchart for illustrating a more detailed operation of the step B7 of FIG. 5. The NFA converting means 22 checks the current node for processing and, if the node is a metacharacter ‘|’ indicating the selection (OR), the NFA converting means 22 takes the left child node to be a new node for processing (step E1) to perform the processing for node conversion thereon (step A4).

If the node for processing is ‘|’, it necessarily has child nodes on the left and right sides. When the processing for the left child node has been finished, the right child node is taken to be a new node for processing (step E2) and processed for node conversion (step A4). When the processing for the right child node has been finished, the processing on ‘|’ of the step B7 (see FIG. 5) is terminated.

Meanwhile, the initial state I and the final state F in carrying out the processing for conversion on the left and right child nodes (step A4) are the same as the initial state I and the final state F, set before start the step B7, respectively (see FIG. 5) (steps E1 and E2).

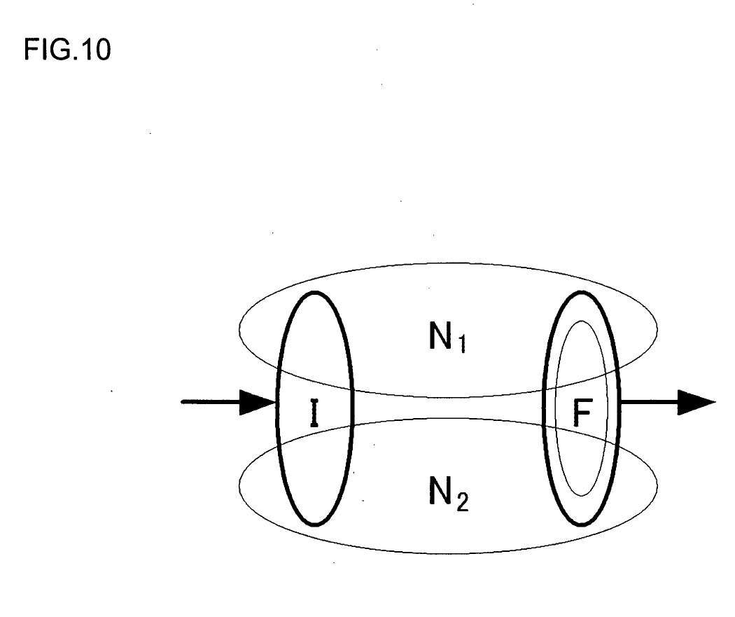

FIG. 10 depicts a conversion pattern to the NFA not including ε-transition, which is applied to the initial state I, to the final state F and to the node ‘|’. In FIG. 10, N₁ and N₂ denote a regular expression represented by a syntax tree having a left child node of the node ‘|’ as a root, and a regular expression represented by a syntax tree having a right child node of the node ‘|’ as a root, respectively.

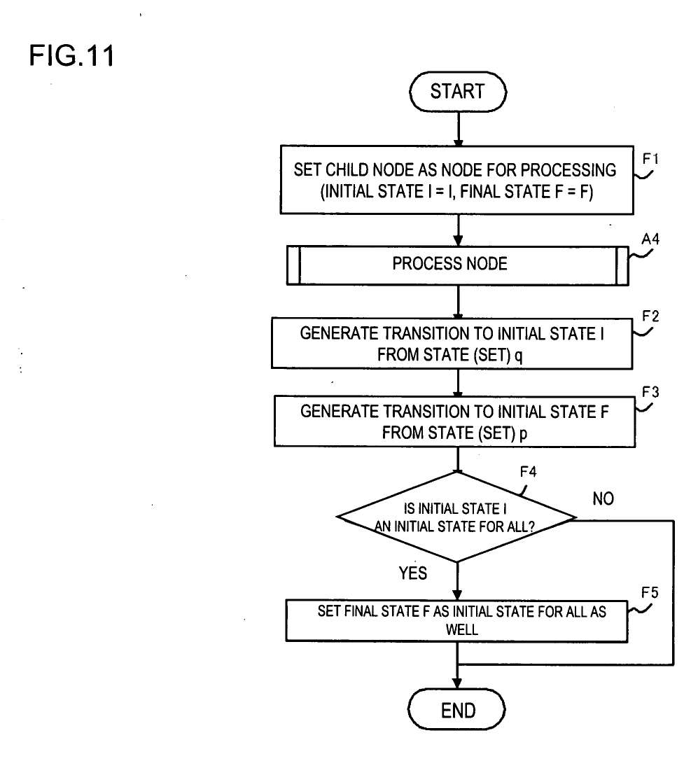

FIG. 11 is a flowchart for illustrating a more detailed operation of the step B9. The NFA converting means 22 checks the current node for processing. If the node for processing is a metacharacter ‘*’ indicating zero time of match or indicating one or more times of match, the NFA converting means 22 takes the child node of the node for processing in question to be a new node for processing (step F1) to perform the processing for node conversion thereon (step A4). There is necessarily one child node for the node ‘*’.

When the processing for conversion for the child node has been finished, the transition from a state q to the initial state I is generated for the state q transitioning to the final state F (step F2). The transition label from the state q to the state I is set so as to be the same as that from the state q to the state F. There may be cases where there is a plurality of states q instead of a sole state q.

The transition from the state p to the final state F is then generated for the state p transitioning to the initial state I (step F3).

At this time, the transition label from the state p to the state F is set so as to be the same as that from the state p to the state I. There may be cases where there is a plurality of states p instead of a sole state p, or where there is no state p.

After generation of the transition from the state p to the state F, it is checked whether or not the initial state I is the initial state of the NFA in its entirety (step F4).

If the initial state I is the initial state of the NFA in its entirety, the final state F is also taken to be the initial state of the NFA in its entirety (step F5) to terminate the processing for ‘*’ (step B9).

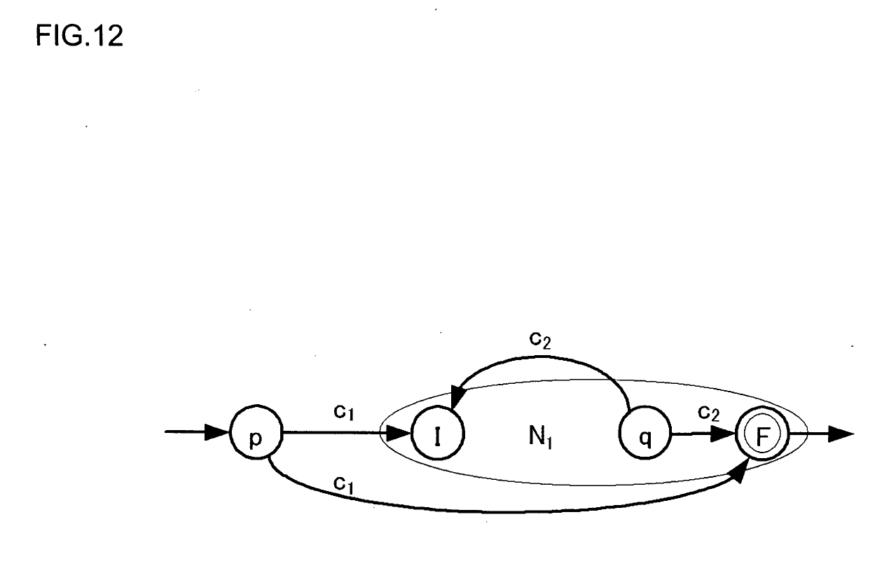

FIG. 12 is a conversion pattern for the NFA, not including ε-transition, applied to the initial state I, to the final state F and to the node ‘*’. In FIG. 12, N₁ denotes a regular expression represented by a syntax tree having a child node of the node ‘*’ as a root. The state p shows a state having a transition with a label c₁ to the state I, and the state q shows a state having a transition with a label c₂ to the state F. Here, such a case is shown in which there are a sole state p and a sole state q.

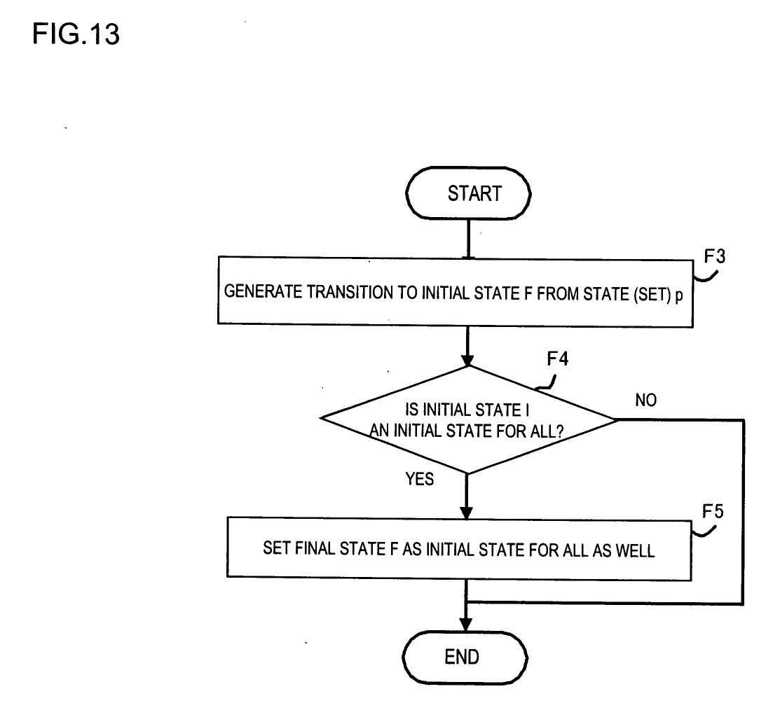

FIG. 13 is a flowchart for illustrating a more detailed operation of a step B11. The NFA converting means 22 checks the current node for processing. If the node is a symbol ‘Φ’ representing empty, the transition from a state p to the final state F is generated for the state p transitioning to the initial state I, as in the steps F3 to F5 in the step B9 (step F3). The NFA converting means 22 then checks to see whether or not the initial state I is the initial state of the NFA in its entirety (step F4). If the initial state I is the initial state of the NFA in its entirety, the final state F is also set so as to be the initial state of the NFA in its entirety (step F5). The processing for ‘Φ’ (step B11) is then terminated.

The processing in the steps F3, F4 and F5 is the same as that in the step B9 and hence is not described in detail.

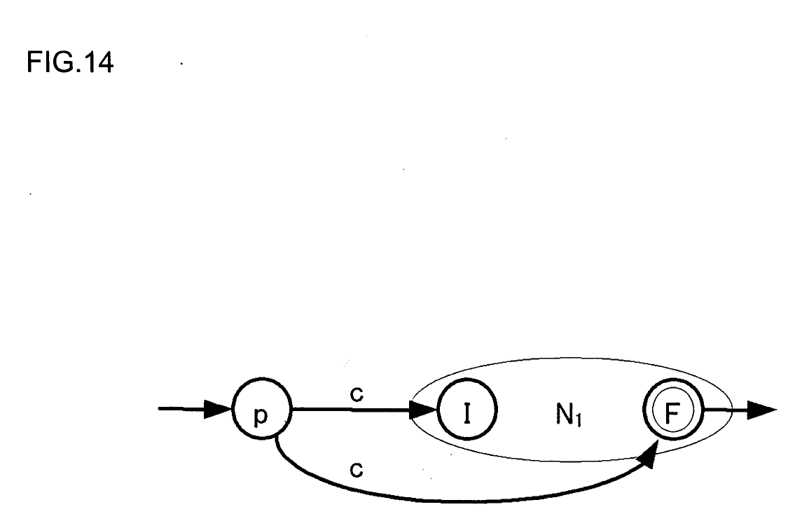

The symbol ‘Φ’ is used in “(N₁|Φ)” rewritten from a regular expression “N₁?”, which uses a metacharacter ‘?’ meaning a zero time of match or meaning only one time of match. The regular expression “(N₁|Φ)”, that is, the regular expression “N₁?”, is generated with the processing for ‘Φ’ (step B11) by the NFA not including ε-transition shown in FIG. 14. This NFA is to be a conversion pattern applied to the symbol ‘Φ’ representing empty. In FIG. 14, N₁ means the regular expression N₁ in “(N₁|Φ)” rewritten from the regular expression “N₁?”. The state p of FIG. 14 indicates a state having the transition with the label c to the state I. In the case shown here, there is only one state p.

By the NFA converting means 22 performing the above mentioned processing for node conversion (step A4) on the root node, the processing for node conversion may recursively be carried out for all of the nodes of the syntax tree (step A4).

When the processing for all of the nodes (step A4) is finished, the processing in its entirety comes to a close.

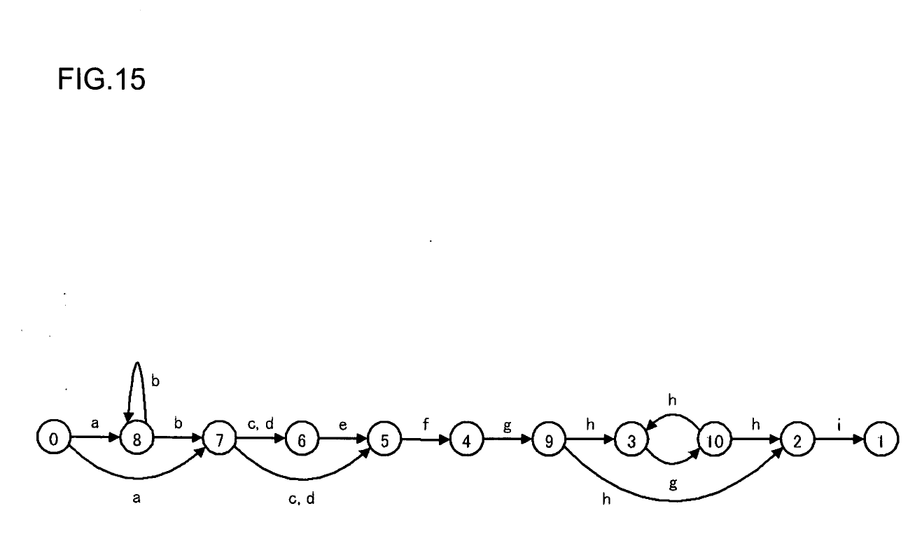

FIG. 15 shows an NFA, not including ε-transition, converted from a syntax tree (FIG. 3) converted in turn from a regular expression “ab*(c|d)e?f(gh)+i”, as an example.

When the processing in its entirety has been finished, the NFA converting means 22 causes ultimate NFA data to be stored in the NFA storage unit 32, while outputting the data to the output device 4.

The operation and the meritorious effect of the first exemplary embodiment of the present invention will now be described.

In the present first exemplary embodiment of the present invention, in which the conversion pattern for conversion into the NFA not including ε-transition is used to effect conversion into NFA, the NFA not including ε-transition may directly be generated by inputting a syntax tree converted from the regular expression.

If desired to convert a syntax tree, converted from the regular expression, to an NFA not including ε-transition, according to the conventional technique, described above, the processing of O(n) is required in order to effect conversion of the syntax tree to the ε-NFA. In addition, the processing of O(n³) is required to remove ε-transition from ε-NFA. It is noted that n is a length of the regular expression represented in terms of the number of characters.

If conversely the technique for conversion into the NFA not including ε-transition of the present exemplary embodiment is utilized, the processing for node conversion is performed on all of n nodes of the syntax tree converted from the regular expression. A search for the state p or q having transitions to the initial state I or to the final state F is necessary for processing on the metacharacter ‘*’, while a search for the state p having transition to the initial state I is necessary for processing on the symbol ‘Φ’ representing empty. In the present exemplary embodiment, the NFA is represented by a data structure having a state number for the source of transition, a state number for the destination of transition and a character of the condition for transition, as shown in FIG. 4. This data structure is such a one in which, by directing the attention on the state number of the destination of transition, the state of the source of the transition, transitioning to the destination state of the transition, and the character as the condition for the transition, may be obtained. It is thus possible to search for the state p or the state q, by steps of O(n), by a search using the state number of the destination of transition as a key. Considering that the number of nodes of the regular expression in the form of a syntax tree is n at the maximum, it becomes possible with the present exemplary embodiment to convert the regular expression represented by the syntax tree to the NFA not including ε-transition by processing with O(n²). This improves the rate of conversion into the NFA not including ε-transition.

In the above mentioned exemplary embodiment, the NFA is stored by the data structure shown in FIG. 4. It is however sufficient that the data structure is such a one in which, with attention directed to a certain state, the state of a source of transition transitioning to this state and the character as the condition for transition may be searched in O(n), n being the number of the states.

Also, in the above mentioned exemplary embodiment, the input syntax tree data is stored by the initial setting means 21 in the syntax tree storage unit 31. When the processing by the initial setting means 21 is finished, the so stored data is read out from the syntax tree storage unit 31 and thence transferred to the NFA converting means 22. It is however possible for the initial setting means 21 to store the syntax tree data received in the syntax tree storage unit 31 and to reference to the so stored data to perform its initializing operation.

The NFA converting means 22 performs the processing for conversion on the syntax tree data received from the initial setting means 21. When the processing in the initial setting means 21 is finished, the initial setting means 21 may supply only a signal indicating the end of the processing to the NFA converting means 22. The NFA converting means 22 then may perform the processing for conversion as it references to the syntax tree data from the syntax tree storage unit 31.

In a similar manner, with the present exemplary embodiment, the NFA data, set by the initial setting means 21, is stored in the NFA storage unit 32. The NFA converting means 22 may reference to the so stored NFA data to perform the processing for conversion into the NFA as it updates the NFA data. When the processing for initialization is finished, the initial setting means 21 may supply the initialized NFA data, along with the signal indicating the end of the processing, to the NFA converting means 22. The NFA converting means 22 may then store the data in the NFA storage unit 32 and perform the processing for conversion as it updates the NFA data in the course of conversion and storage thereof in the NFA storage unit 32.

With the aid of the syntax tree storage unit 31 and the NFA storage unit 32, the input device is able to receive new syntax tree data without waiting for the end of the processing by the initial setting means 21. In similar manner, the initial setting means 21 is able to start the processing for initialization of the next NFA, without waiting for the end of the processing by the NFA converting means 22, provided that there is new syntax tree data in the syntax tree storage unit 31. The NFA converting means 22 is able to start the next processing for conversion into NFA, provided that there is new initialized NFA data in the NFA storage unit 32, thus allowing for efficient processing for conversion into NFA.

### Second Exemplary Embodiment

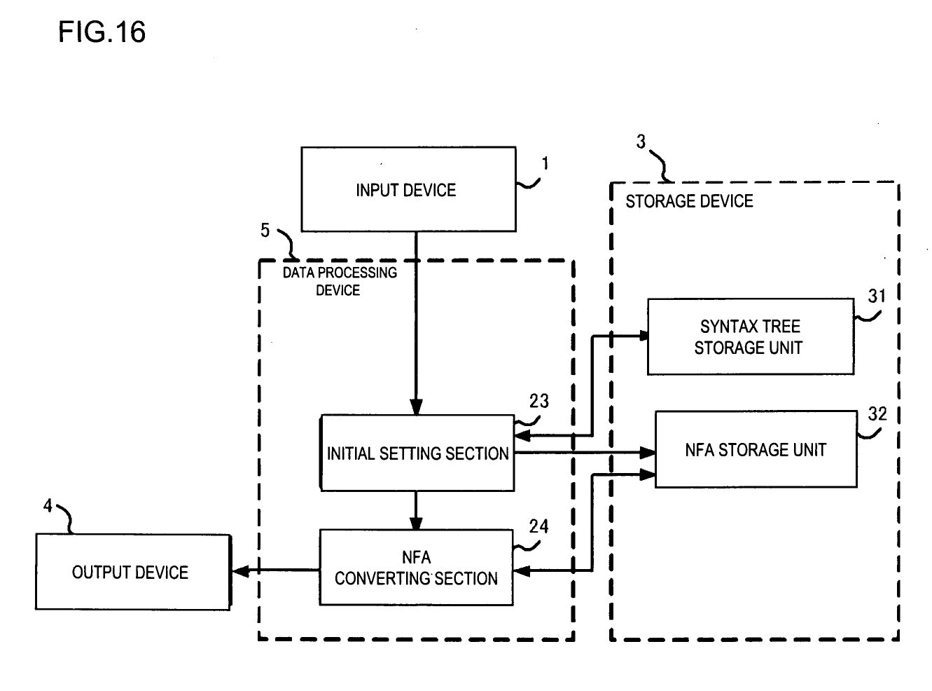

A second exemplary embodiment of the present invention will now be described in detail with reference to the drawings. FIG. 16 is a block diagram showing the configuration of the second exemplary embodiment of the present invention. Referring to FIG. 16, a data processing device 5 includes an initial setting means 23 and an NFA converting means 24. The ‘means’ herein denotes respective processing functions. In the present exemplary embodiment, the initial setting means 23 and the NFA converting means 24 are respectively used in substitution for the initial setting means 21 and the NFA converting means 22 of the above described first exemplary embodiment. Otherwise, the present exemplary embodiment is the same as the above mentioned first exemplary embodiment.

The initial setting means 23 reads in a regular expression, which has been converted into the form of a syntax tree, and which has been input from the input device 1. The initial setting means 23 causes the so read regular expression to be stored in the syntax tree storage unit 31. The initial setting means 23 also initializes the generated NFA depending on the types of the root node, that is, depending on whether the root node is a character or a particular metacharacter. The initial setting means 23 causes the data structure of the initialized NFA to be stored in the NFA storage unit 32.

The NFA converting means 24 receives the data structure, representing the syntax tree, from the initial setting means 23, while reading in a data structure corresponding to the NFA from the NFA storage unit 32.

The NFA converting means 24 applies a conversion pattern for conversion into the NFA not including ε-transition to respective nodes of the syntax tree to effect conversion thereof into the NFA not including ε-transition. In the present exemplary embodiment, the phrase “not including ε-transition” again means not including any routine processing related with ε-transition. When the conversion is finished, the NFA converting means 24 causes the data structure representing the post-conversion NFA to be stored in the NFA storage unit 32, while outputting the data structure to the output device 4.

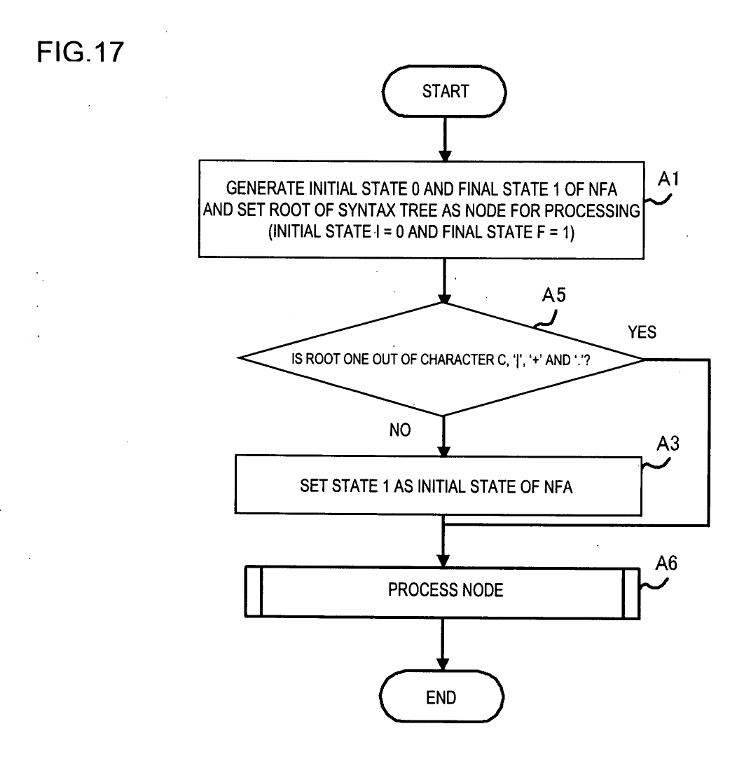

The operation of the second exemplary embodiment of the present invention will now be described in detail with reference to FIGS. 16 and 17.

A regular expression in the form of a syntax tree is supplied from the input device 1 and supplied to the initial setting means 23.

It is assumed that the input syntax tree has been re-written beforehand into a regular expression that uses only four kinds of metacharacters ‘|’, ‘?’, ‘+’ and ‘*’, and has been converted in this form into the syntax tree. The four kinds of metacharacters are made up of the two kinds of the metacharacters of the above mentioned first exemplary embodiment (‘|’ for selection and ‘*’ for zero time of match and for one or more times of match) plus two kinds of the metacharacters (‘?’ for zero time of match or for only one time of match and ‘+’ for one or more times of match). It is also assumed that the syntax tree, obtained on conversion, additionally contains a node (‘?’) for concatenation. The data structure is the same as that of the above mentioned first exemplary embodiment and hence the description thereof is dispended with.

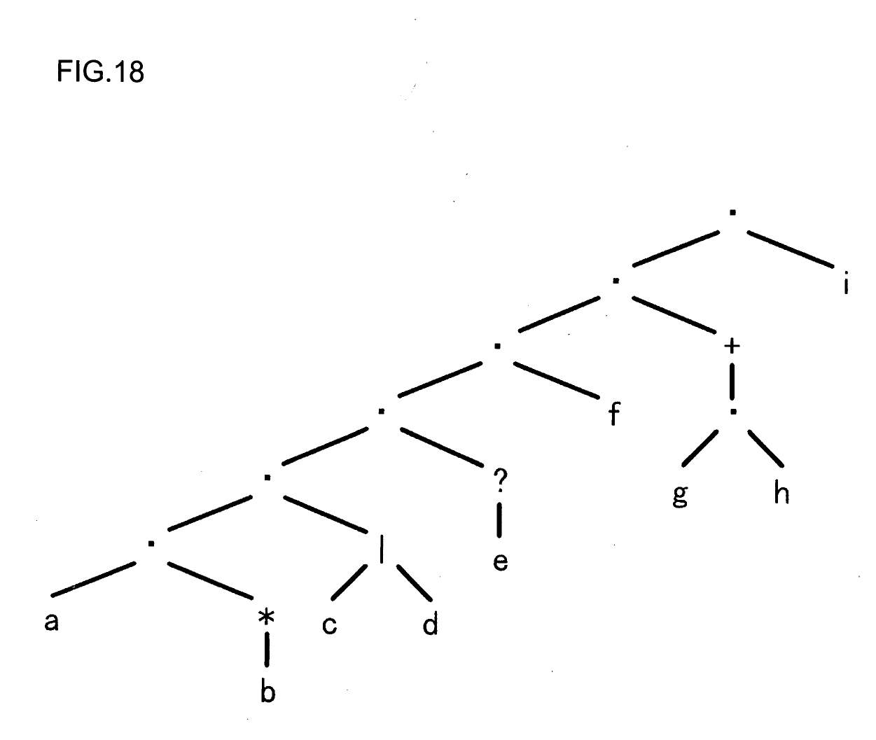

FIG. 18 shows schematics of a syntax tree for a regular expression “ab*(c|d)e?f(gh)+i”.

On receipt of the syntax tree data, the initial setting means 23 causes the data structure, representing the syntax tree, to be stored in the syntax tree storage unit 31. The initial setting means 23 also generates states 0 and 1 and sets the state 0 and the state 1 so as to be the initial state and the final state of the NFA, respectively (step A1).

The initial setting means 23 sets the root node of the input syntax tree so as to be the node for processing, while setting the initial state I and the final state F so as to be the state 0 and the state 1, respectively (step A1). The initial setting means 23 then checks whether or not the root node corresponds with any one of the character, metacharacter ‘|’ or ‘+’ and a symbol ‘•’ representing the concatenation (step A5).

If the root node corresponds with none of these, the state 1 is set so as to be the initial state of the post-conversion NFA as well (step A3). In this case, the state 1 is the initial state of the post-conversion NFA, while also being its final state.

After the end of the above processing (steps A1, A5 and A3), the initial setting means 23 causes the NFA generated to be stored in the NFA storage unit 32. The initial setting means 23 also reads in the syntax tree data from the syntax tree storage unit 31, and supplies the data and the signal to the NFA converting means 24. The NFA, stored in the NFA storage unit 32, may be represented by the same data structure as that of the above mentioned first exemplary embodiment (a two-dimensional array and a linear list shown in FIG. 4) and hence is not described in detail.

On receipt of the processing end signal and the syntax tree data from the initial setting means 23, the NFA converting means 24 performs the processing of node conversion, beginning from the root node as a node for processing (step A6).

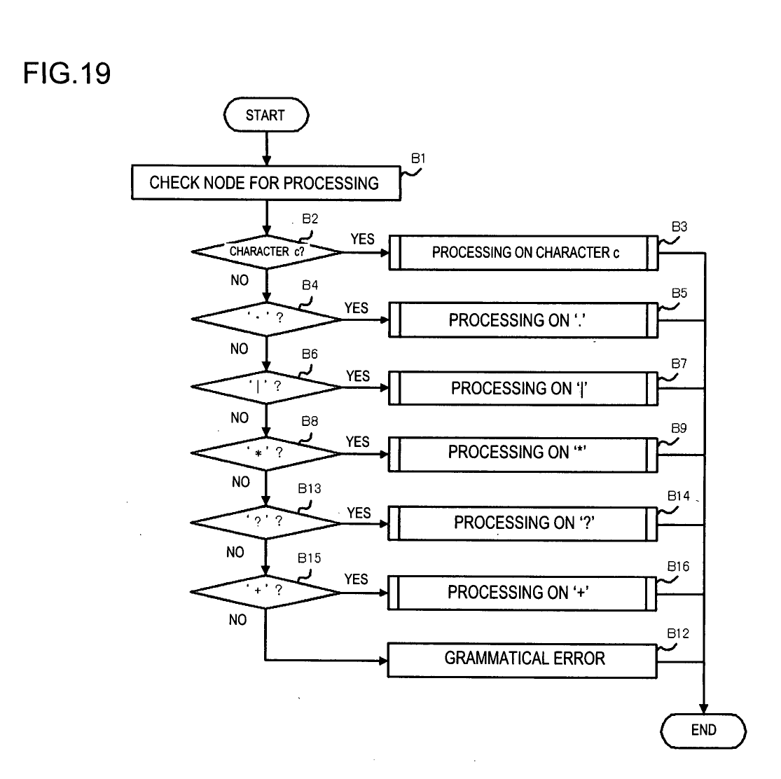

FIG. 19 is a flowchart for illustrating a more detailed operation of the step A6. As in the step A4 for processing for node conversion of the first exemplary embodiment, the NFA converting means 24 checks the node for processing (step B1). If the node for processing is a character, a symbol ‘•’ indicating the concatenation, a metacharacter ‘|’ or a metacharacter ‘*’, the NFA converting means 24 performs the corresponding processing (steps B2 through to B9).

If the node for processing is a metacharacter ‘?’ for zero time of match or for only one time of match, the NFA converting means 24 performs the processing for ‘?’ (steps B13 and B14). If the node for processing is a metacharacter ‘+’ indicating one or more times of match, the NFA converting means 24 performs the processing for ‘+’ (steps B15 and B16).

If the node for processing corresponds to none of the above, the NFA converting means 24 decides that a syntax error has occurred and performs the processing for error for the NFA for the regular expression in question (step B12).

Since the processing for the steps B1 to B9 and for the step B12 is the same as that for the first exemplary embodiment, the detailed description thereof is omitted.

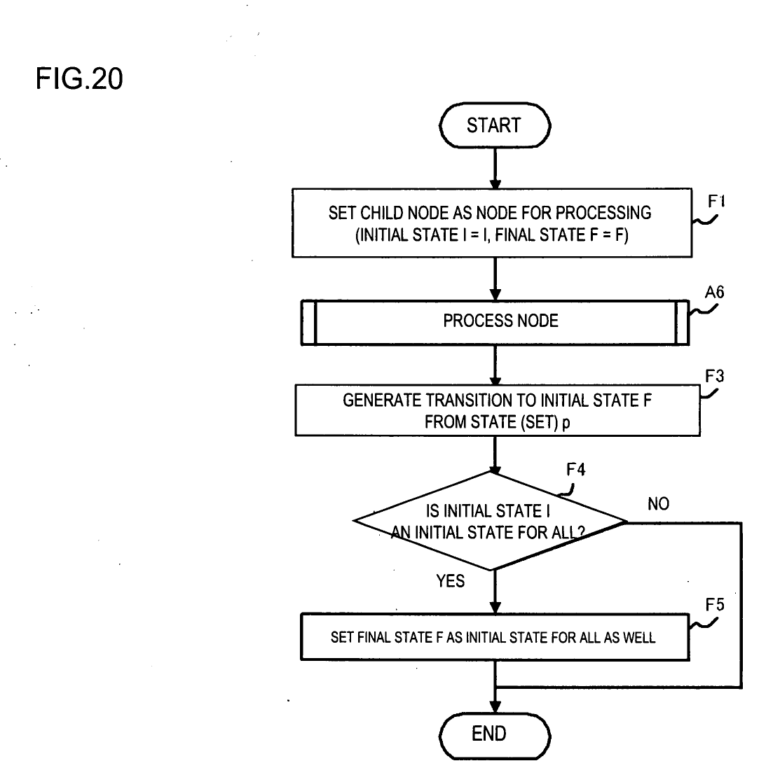

FIG. 20 is a flowchart for illustrating a more detailed operation of the step B14. The NFA converting means 24 checks the current node for processing. If the node is a metacharacter ‘?’ indicating a zero time of match or one time of match, the NFA converting means 24 takes a child node of the node for processing in question to be a new node for processing (step F1) to perform the processing for node conversion thereon (step A6).

Here, it should be noted that there is necessarily one child node for the node ‘?’.

When the processing for conversion of the child node is finished, the transition from a state p to the final state F is generated for the state p transitioning to the initial state I. In case the initial state I is the initial state of the NFA in its entirety, the final state F is also set so as to be the initial state of the NFA in its entirety (steps F3 to F5) to terminate the processing for ‘?’ (step B14). The steps F1 and F3 to F5 are the same as those in the first exemplary embodiment and hence are not described in detail. The conversion pattern into the NFA, not including ε-transition, applied to the initial state I, to the final state F and to the ‘?’ node, is the same as those of FIG. 14. In this case, N₁ in FIG. 14 means a regular expression represented by a syntax tree having a child node of the node ‘?’ as a root.

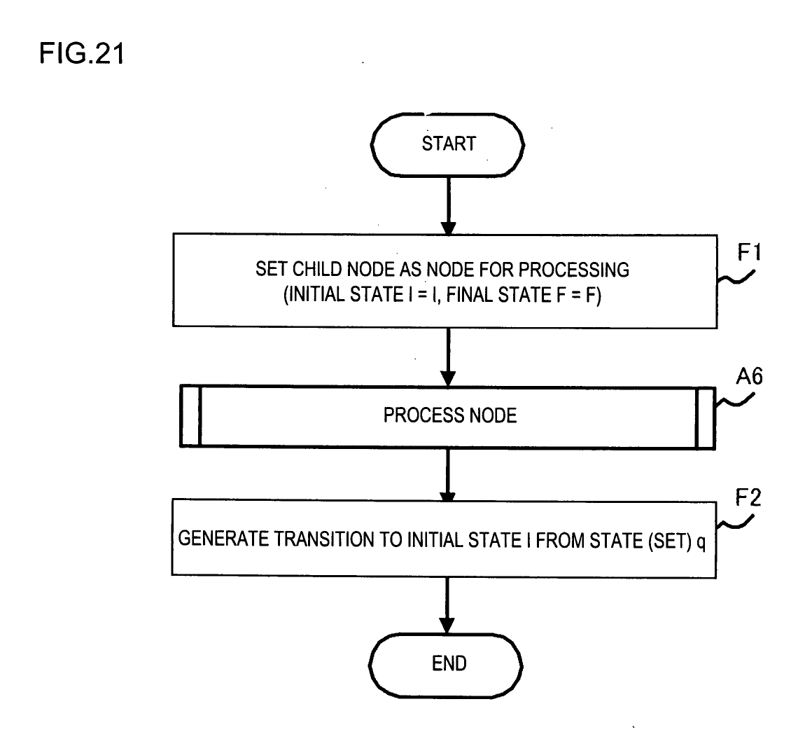

FIG. 21 is a flowchart for illustrating a more detailed operation of the step B16. The NFA converting means 24 checks the current node for processing and, if the node is the metacharacter ‘+’ indicating one or more times of match, the NFA converting means 24 takes the child node of the node for processing in question to be a new node for processing (step F1) to perform the processing for node conversion thereon (step A6).

Here, it should be noted that there is necessarily one child node of the node ‘+’.

When the processing for conversion for the child node has been finished, the transition from a state q to the initial state I is generated for the state q transitioning to the final state F (step F2) to complete the processing for ‘+’ (step B16).

Since the steps F1 and F2 are the same as those of the first exemplary embodiment, the detailed description thereof is omitted.

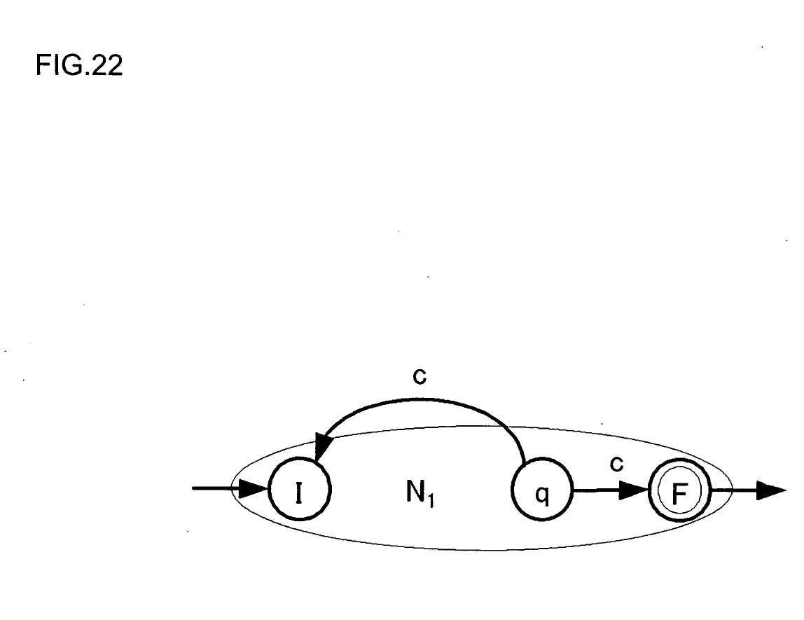

FIG. 22 shows a conversion pattern into the NFA, not including ε-transition, applied to the initial state I, to the final state F and to the ‘+’ node. In FIG. 22, N₁ denotes a regular expression represented by a syntax tree having a child node of the ‘+’ node as a root, and the state q indicates a state having a transition to the state F with a label c. Here, a case in which there is a single state q is shown. It is assumed that, in the second exemplary embodiment, the processing for node conversion carried out during each processing step is the processing for node conversion (step A6) in its entirety.

The NFA converting means 24, performing the above mentioned processing for node conversion on the root node (step A6), is able to recursively perform the processing for node conversion on all of the nodes of the syntax tree (step A6). When the processing for node conversion on all of the nodes (step A6) is finished, the processing in its entirety is finished.

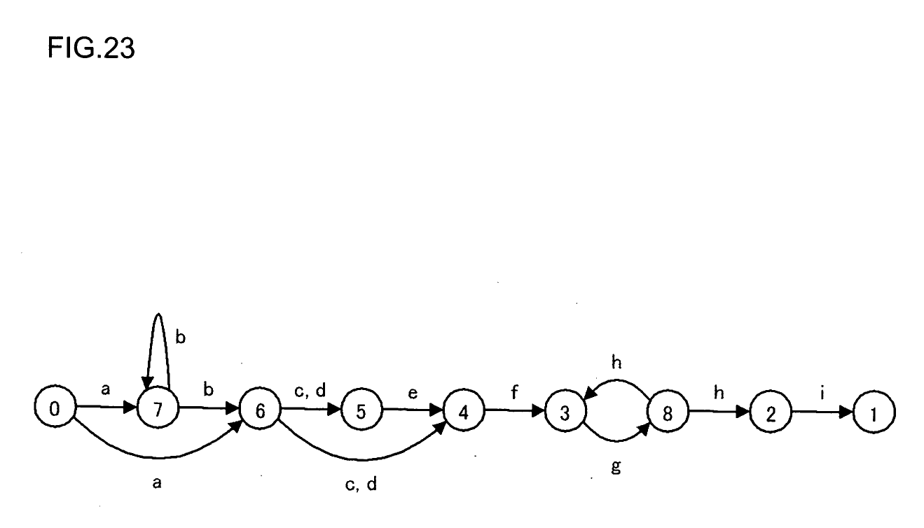

FIG. 23 shows the concept in converting into an NFA of a syntax tree (FIG. 18) converted from a regular expression “ab*(c|d)e?f(gh)+i”, as an example. When the processing in its entirety is finished, the NFA converting means 24 causes the ultimate NFA data to be stored in the NFA storage unit 32, while outputting the data to the output device 4.

The operation and the meritorious effect of the second exemplary embodiment of the present invention will now be described.

With the second exemplary embodiment of the present invention, as in the above described first exemplary embodiment, a converting means (conversion patterns) into an NFA not including ε-transition is used for converting into an NFA. In this case, an NFA not including ε-transition may directly be generated from a regular expression via a syntax tree. In addition, the speed of conversion into an NFA may be improved because the processing is O(n²) processing.

In addition, in the second exemplary embodiment of the present invention, in distinction from the above described first exemplary embodiment, a syntax tree that uses, as nodes, a sum total of four kinds of metacharacters and the symbol ‘•’, indicating the concatenation, may directly converted into an NFA not including ε-transition. The four kinds of metacharacters are the two kinds of the metacharacters ‘|’ and ‘*’ plus the two kinds of metacharacters ‘?’ and ‘+’.

In particular, in the case of a regular expression that uses the metacharacter ‘+’, it has conventionally been necessary to use “N₁N₁*” in place of “N₁+” for conversion. Hence, the state of a portion “N₁” of the regular expression is generated in excess. This re-writing is unneeded in the present exemplary embodiment. It is thus possible to prevent the number of the states of a portion of the regular expression that uses the metacharacter ‘+’ from increasing.

In the second exemplary embodiment, as in the above described first exemplary embodiment, an NFA is retained by a data structure shown in FIG. 4. It is however sufficient that the data structure is such a one in which, with the number of states being n, and attention directed to a given state, the state of the source of transition, transitioning to the given state, and the character, as its condition for transition, may be searched in O(n).

In addition, with the present exemplary embodiment, input syntax tree data is stored by the initial setting means 23 in the syntax tree storage unit 31. When the processing by the initial setting means 23 is finished, the data stored is read out from the syntax tree storage unit 31 and transferred to the NFA converting means 24. It is however possible for the initial setting means 23 to store the input syntax tree data in the syntax tree storage unit 31 to reference to the so stored syntax tree data to perform its processing.

The NFA converting means 24 performs the processing for conversion using the syntax tree data received from the initial setting means 23. It is noted that, when the processing by the initial setting means 23 is finished, the initial setting means 23 may supply only a signal indicating the end of the processing to the NFA converting means 24. The NFA converting means 24 may then perform the processing for conversion as it references to the syntax tree data from the syntax tree storage unit 31.

In the present exemplary embodiment, the NFA data, set by the initial setting means 23, is stored in the NFA storage unit 32, with the NFA converting means 24 then referencing to and updating the so stored NFA data to perform the processing for conversion thereof into an NFA. When the processing for initialization is finished, the initial setting means 23 may supply initialized NFA data, along with the signal indicating the end of the processing, to the NFA converting means 24. The NFA converting means 24 may then cause the data to be stored in the NFA storage unit 32 to perform the processing for conversion as it updates the NFA data from the NFA storage unit 32 as the data is being converted.

In the present second exemplary embodiment, provided with the syntax tree storage unit 31 and the NFA storage unit 32, it is possible for the input device 1, initial setting means 23 and the NFA converting means 24 to start the next processing for new data, if any, without waiting for the end of the processing in respective other means, as in the first exemplary embodiment. It is thus possible to realize highly efficient processing for conversion into NFA.

### Third Exemplary Embodiment

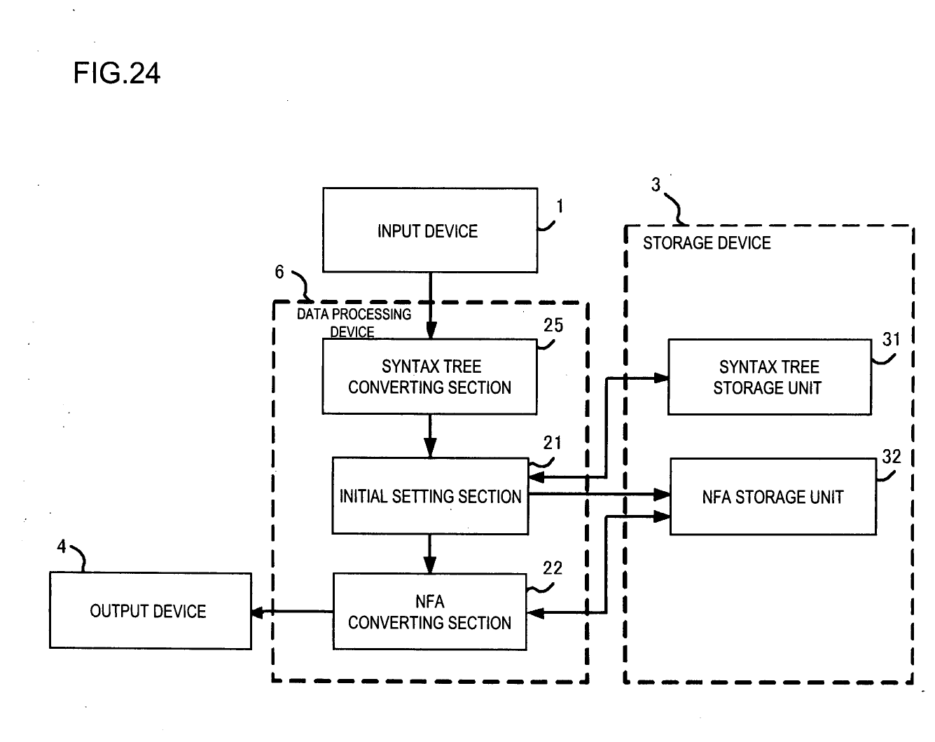

A third exemplary embodiment of the present invention will now be described. FIG. 24 is a block diagram showing the configuration of the third exemplary embodiment of the present invention. Referring to FIG. 24, showing the third exemplary embodiment, a data processing device 6 includes a syntax tree converting means 25, an initial setting means 21 and an NFA converting means 22. The ‘means’ herein denotes respective processing functions. In the present exemplary embodiment, the syntax tree converting means 25 is additionally provided in the data processing device 2 of the above described first exemplary embodiment. Otherwise, the present third exemplary embodiment is the same as the above described first exemplary embodiment.

The syntax tree converting means 25 reads in the regular expression, as the target for conversion, delivered from the input device 1, and rewrites the regular expression into another regular expression that uses only the two kinds of the metacharacters of ‘|’ (selection) and ‘*’ (for zero time of match or for one or more times of match). The regular expression is then converted into a syntax tree which is then supplied to the initial setting means 21 along with a signal indicating the end of the processing. It is noted that this syntax tree uses, as nodes, the symbol ‘•’ for concatenation and the symbol ‘Φ’ representing empty.

The processing subsequent to receipt of the signal for the end of the processing by the initial setting means 21 from the syntax tree converting means 25 is the same as that of the above described first exemplary embodiment, and hence is not described.

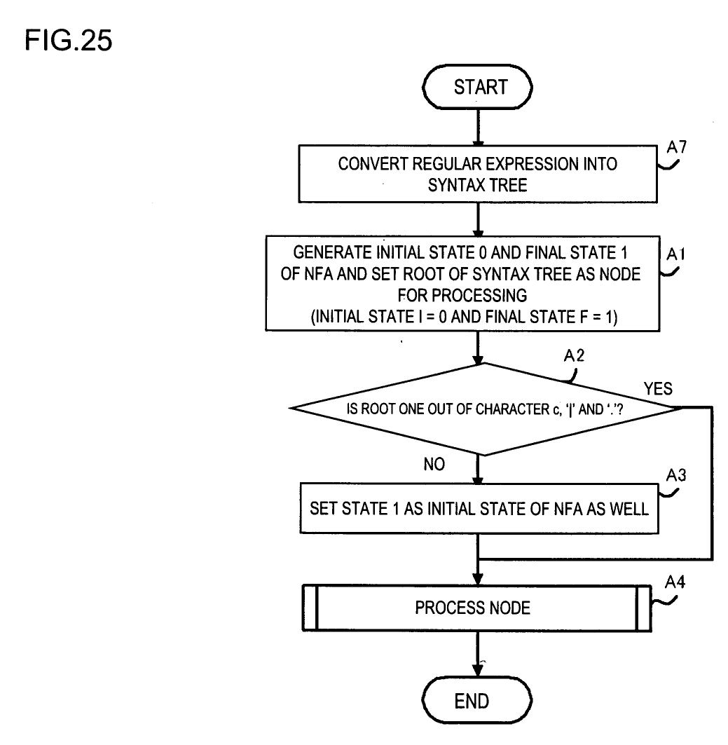

Referring to FIGS. 24 and 25, the operation of the third exemplary embodiment of the present invention will be described in detail.

In the present exemplary embodiment, the regular expression itself is entered from the input device 1. The input regular expression is delivered to the syntax tree converting means 25.

The syntax tree converting means 25 rewrites the input regular expression into another regular expression that uses only two kinds of the metacharacters ‘|’ for selection (OR) and ‘*’ for zero time of match or for one or more times of match.

After performing rewriting of the regular expression, the syntax tree converting means 25 converts the rewritten regular expression into a syntax tree, and sends a resulting data structure, representing the syntax tree, to the initial setting means 21 along with the signal indicating the end of the processing (step A7). The syntax tree uses, as nodes, the symbol ‘•’ for concatenation and the symbol ‘Φ’ representing empty. In the processing for rewriting the regular expression into the regular expression that uses only the above mentioned two kinds of the metacharacters, the regular expression in question may first be rewritten using ‘•’ and ‘Φ’, such as by rewriting “ab?c” to “a•(b|Φ)•c”, after which the resulting regular expression is converted into a syntax tree. Or, the regular expression in question may first be rewritten into the other regular expression without using these symbols, such as by rewriting “ab?c” to “a(b|)c” and, in converting the resulting regular expression into a syntax tree, the symbols ‘•’ and ‘Φ’ may be added as nodes. Also, ‘•’ may be added when converting the regular expression to a syntax tree and ‘Φ’ may be added when rewriting the regular expression, or vice versa. It is sufficient that the nodes ‘•’ and ‘Φ’ are used ultimately at a time point of completion of conversion into the syntax tree.

The data structure indicating the syntax tree is the same as that of the first exemplary embodiment, and any suitable technique used conventionally may be used as the processing for generating a syntax tree from a regular expression. Hence, the explanation for such technique is dispensed with. For example, if the regular expression “ab*(c|d)e?f(gh)+i” is entered, a syntax tree shown in FIG. 3 is generated.

After the initial setting means 21 has received the signal indicating the end of the processing and the syntax tree data from the syntax tree converting means 25, the operation subsequent to the step A 1 is the same as that of the first exemplary embodiment. Hence, the operation is not described in detail.

The operation and the meritorious effect of the third exemplary embodiment of the present invention will now be described.

With the third exemplary embodiment of the present invention, as in the above described first exemplary embodiment, conversion means (conversion patterns) into an NFA not including ε-transition is used for conversion into an NFA. In this case, an NFA not including ε-transition may directly be generated from the regular expression via a syntax tree. In addition, the speed of conversion into an NFA may be increased because the processing is O(n²) processing.

With the third exemplary embodiment of the present invention, in distinction from the above described first exemplary embodiment, the regular expression itself is entered and converted into a syntax tree as an intermediate stage. This renders it possible to directly convert the input regular expression into an NFA not including ε-transition.

In the above described third exemplary embodiment, the regular expression is converted by the syntax tree converting means 25 into the syntax tree and resulting syntax tree data is supplied to the initial setting means 21 along with the signal indicating the end of processing. Alternatively, once the conversion into a syntax tree is finished, the syntax tree converting means 25 may cause the syntax tree data to be stored in the syntax tree storage unit 31. Only the signal indicating the end of processing may then be supplied to the initial setting means 21. The initial setting means 21 may read in the syntax tree data from the syntax tree storage unit 31 on receipt of the processing end signal. The subsequent processing is the same as that of the first exemplary embodiment.

In addition, in the above described third exemplary embodiment, the syntax tree converting means 25 is additionally provided as new element to the arrangement of the data processing device 2 of the above described first exemplary embodiment. The syntax tree converting means 25 rewrites the input regular expression into another regular expression that uses only the two kinds of the metacharacters ‘|’ and ‘*’. This other regular expression is converted into a syntax tree that uses as nodes the symbol ‘•’ for concatenation and the symbol ‘Φ’ representing empty. The resulting syntax tree is supplied to the initial setting means 21 along with the signal indicating the end of processing. The processing as from the step A7 is the same as in the above described first exemplary embodiment.

In the above described third exemplary embodiment, the syntax tree converting means 25 is newly added to the arrangement of the data processing device 5 of the above described second exemplary embodiment. This syntax tree converting means 25 rewrites the input regular expression into another regular expression that uses only the four kinds of the metacharacters ‘|’, ‘?’, ‘+’ and ‘*’. After performing the step A7 in which the resulting regular expression is converted into a syntax tree that uses a symbol ‘•’ indicating the concatenation as a node, and the resulting syntax tree is then sent, along with the processing end signal, to the initial setting means 23, the operation same as that of the above described second exemplary embodiment may be performed. As regards the processing of rewriting the regular expression into the other regular expression that uses only the above mentioned four kinds of the metacharacters, the regular expression in question may be rewritten using ‘•’, such as by rewriting “ab?c” into “a•b?•c”, after which the so rewritten regular expression may be converted into the syntax tree. These symbols may not be used, in which case the symbol ‘•’ may be additionally provided as a node at the time of conversion into the syntax tree. It is sufficient that the node ‘•’ is ultimately used at the time of conversion into the syntax tree.

### Fourth Exemplary Embodiment

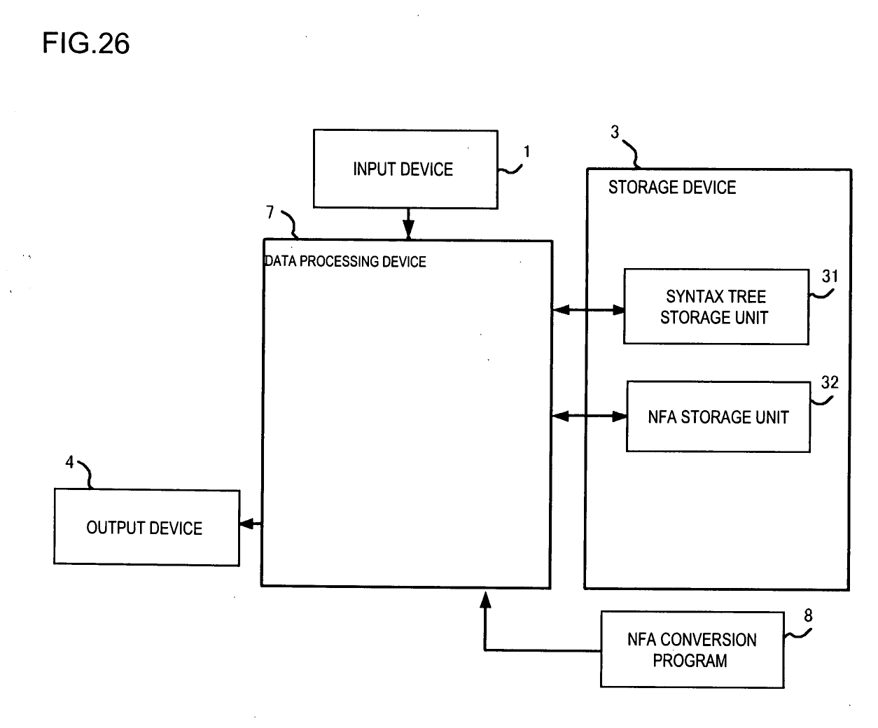

A fourth exemplary embodiment of the present invention will now be described. FIG. 26 is a block diagram showing an arrangement of the fourth exemplary embodiment of the present invention. Referring to FIG. 26, the fourth exemplary embodiment of the present invention includes, as in the first to third exemplary embodiments, described above, an input device 1, a data processing device 7 (2, 5, 6), a storage device 3 and an output device 4. In the present exemplary embodiment, the processing by the initial setting means 21 and the NFA converting means 22 of the data processing device 2 of the above described first exemplary embodiment, that by the initial setting means 23 and the NFA converting means 24 of the data processing device 5 of the above described second exemplary embodiment, and that by the initial setting means 21, NFA converting means 22 and the syntax tree converting means 25 of the data processing device 6 of the above described third exemplary embodiment, are implemented by an NFA converting program 8 which is executed on the data processing device 7.

The NFA converting program 8 is read by the data processing device 7 to control the operation of the data processing device 7 to generate the syntax tree storage unit 31 and the NFA storage unit 32 in the storage device 3.

The data processing device 7 operates under control by the NFA converting program 8 to execute the same processing as the processing of the data processing devices 2, 5 and 6 of the first to third exemplary embodiments.

The present exemplary embodiment, described above, yields the following meritorious effects:

In the present exemplary embodiment, a regular expression is converted through the stage of a syntax tree so that the conversion into an NFA not including ε-transition may be processed at a high speed.

That is, in the exemplary embodiments, described above, conversion means (conversion patterns) into the NFA not including ε-transition is applied to effect conversion into an NFA. To perform the conversion into an NFA, such a data structure is used which includes a state number of the source of transition, a state number of the destination of transition and a character as a condition for transition. In this data structure, with the number of states being n, and with attention directed to a certain state, the state of the source of transition transitioning to this state may be searched in O(n). There is thus no necessity of performing the processing of removing the ε-transition (ε-closure), which processing has been necessary with the conventional technique. An NFA not including ε-transition may thus be directly generated from the regular expression through the stage of the syntax tree. Meanwhile, with the length n (number of characters) of the regular expression, the processing of O(n³) is necessary with the conventional technique for conversion into an NFA, while the conversion into an NFA may be achieved with the processing of O(n²) with the use of the present invention.

In addition, in the present exemplary embodiment, a conversion pattern for each of the metacharacters ‘?’ and ‘+’ is used. By so doing, it is unnecessary to rewrite these two kinds of the metacharacters at the time of conversion from the regular expression to the syntax tree.

If, in the conventional conversion from the regular expression into an NFA, a regular expression is to be converted to a syntax tree, it has been necessary that a regular expression of interest is first rewritten to another regular expression that uses only two kinds of metacharacters ‘|’ and ‘*’. The resulting regular expression is then converted into a syntax tree that uses a symbol ‘•’ for concatenation as a node. With the present exemplary embodiment, a conversion pattern for each of the metacharacters ‘?’ and ‘+’ may be used, and hence the metacharacters ‘?’ and ‘+’ may appear as nodes in the syntax tree as well. By applying respective conversion patterns for the processing for node conversion, it becomes possible to effect direct conversion into an NFA not including ε-transition.

In the present exemplary embodiment, the number of the states of the NFA generated may be reduced by applying conversion patterns for the metacharacter ‘+’.

In converting a regular expression such as “N+”, by the conventional technique, it has been necessary that the regular expression is once rewritten to “NN*” after which the syntax tree is generated. As a result, the NFA indicating the regular expression represented by N appears twice. In the present exemplary embodiment, in which the conversion pattern for the metacharacter ‘+’ is applied, the NFA indicating the regular expression represented by N appears only once. That is, the number of states of the ultimately generated NFA may be reduced by the number of states included in the regular expression represented by “N+”.

### INDUSTRIAL APPLICABILITY

The present invention may be applied to a field of use, exemplified by a program for high-speed generation of an NFA, not including ε-transition, used for pattern matching that makes use of a regular expression.

The present invention may also be applied to a field of use exemplified by a system or a program for generating an NFA used for implementing a hardware circuit. It is noted that an NFA, implemented as a hardware circuit, allows for high-speed pattern matching employing a regular expression.

The present invention may also be used for generating an NFA used for executing a pattern matching which is performed on the basis of the software onboard a personal computer or a workstation. In these cases, it is sufficient that a computer program provided in an information processing device is stored in a memory device (memory medium) such as a read-write memory or a hard disc device. In these cases, the present invention may be implemented by the code of a relevant computer program or a memory medium.

The particular exemplary embodiments or examples may be modified or adjusted within the gamut of the entire disclosure of the present invention, inclusive of claims, based on the fundamental technical concept of the invention. Further, a large variety of combinations or selection of elements disclosed herein may be made within the framework of the claims. That is, the present invention may encompass various modifications or corrections that may occur to those skilled in the art in accordance with and within the gamut of the entire disclosure of the present invention, inclusive of claim and the technical concept of the present invention.

1. A system for generating a non-deterministic finite automaton (NFA) not including ε-transition, the system comprising:
an initial setting section that performs initial setting of a non-deterministic finite automaton to be generated; and
an NFA converting section that directly generates a non-deterministic finite automaton not including ε-transition based on a regular expression represented by a syntax tree.

2. The system according to claim 1, wherein
the NFA converting section converts the regular expression represented by a syntax tree into a non-deterministic finite automaton not including ε-transition depending on the type of each node of the regular expression represented by a syntax tree,
said non-deterministic finite automaton having a data structure including:
a state of a source of transition;
a state of a destination of transition; and
a condition for transition.

3. The system according to claim 1, further comprising:
a syntax tree storage unit that stores a regular expression as a syntax tree that uses a character, a predetermined metacharacter and symbol; and
an NFA storage unit that stores said non-deterministic finite automaton which is being converted or which has been converted by said NFA converting section,
the initial setting section that performs initial setting of said non-deterministic finite automaton depending on the type of a root node of said syntax tree stored in said syntax tree storage unit,
the NFA converting section performing conversion of each node of said syntax tree into said non-deterministic finite automaton not including ε-transition.

4. The system according to claim 3, said system comprising:
a syntax tree converting section that converts a regular expression into a syntax tree that uses a character, a predetermined metacharacter and a symbol,
said syntax tree converting section causing said syntax tree converted to be stored in said syntax tree storage unit.

5. The system according to claim 3 wherein said NFA converting section references to said syntax tree stored in said syntax tree storage unit and to a non-deterministic finite automaton stored in said NFA storage unit,
said NFA converting section applies a conversion pattern for conversion into a non-deterministic finite automaton not including ε-transition to each node of said syntax tree to effect conversion thereof to a non-deterministic finite automaton not including ε-transition, and
said NFA converting section causes the non-deterministic finite automaton generated to be stored in said NFA storage means and outputs the non-deterministic finite automaton generated at an output device.

6. The system according to claim 3, wherein said regular expression, represented by said syntax tree, is described by part or all of a character, a metacharacter indicating the selection, a metacharacter indicating a zero time of match or indicating one or more times of match, a symbol indicating the concatenation and a symbol representing empty.

7. The system according to claim 3, wherein said regular expression, represented by said syntax tree, is described by part or all of a character, a metacharacter indicating the selection, a metacharacter indicating a zero time of match or only one time of match, a metacharacter indicating one or more times of match, a metacharacter indicating a zero time of match or indicating one or more times of match, and a symbol indicating the concatenation.

8. A method for generating a non-deterministic finite automaton not including ε-transition, the method comprising:
performing initial setting of an non-deterministic finite automaton to be generated; and
directly generating a non-deterministic finite automaton not including ε-transition based on a regular expression represented by a syntax tree.

9. The method according to claim 8, comprising:
in generating an non-deterministic finite automaton not including ε-transition,
converting the regular expression represented by a syntax tree into a non-deterministic finite automaton not including ε-transition depending on the type of each node of the regular expression represented by a syntax tree,
said non-deterministic finite automaton having a data structure including:
a state of a source of transition;
a state of a destination of transition; and
a condition for transition.

10. The method according to claim 8, comprising:
storing a regular expression in a storage medium as a syntax tree that uses a character, a predetermined metacharacter and a symbol;
in performing the initial setting, performing initial setting of a non-deterministic finite automaton depending on the type of a root node of said syntax tree stored in said storage medium;
in generating an non-deterministic finite automaton not including ε-transition, directly converting each node of said syntax tree into said non-deterministic finite automaton not including ε-transition; and
storing said non-deterministic finite automaton which is being converted or which has been converted in said storage medium.

11. The method according to claim 8, comprising:
converting a regular expression into a syntax tree that uses a character, a predetermined metacharacter and a symbol to store the resulting syntax tree in a storage medium;
in performing the initial setting, performing initial setting of an non-deterministic finite automaton depending on the type of a root node of said syntax tree stored;
in generating an non-deterministic finite automaton not including ε-transition, directly converting each node of said syntax tree into said non-deterministic finite automaton not including ε-transition; and
storing said non-deterministic finite automaton which is being converted or which has been converted in said storage medium.

12. The method according to claim 10, comprising:
referencing to said syntax tree and a non-deterministic finite automaton, stored in said storage means;
applying a conversion pattern for conversion into a non-deterministic finite automaton not including ε-transition to each node of said syntax tree to effect conversion thereof to a non-deterministic finite automaton not including ε-transition; and
causing the non-deterministic finite automaton generated to be stored in said storage means and outputting the non-deterministic finite automaton generated at an output device.

13. The method according to claim 11, wherein said regular expression, represented by said syntax tree, is described by part or all of a character, a metacharacter indicating the selection, a metacharacter indicating a zero time of match or indicating one or more times of match, a symbol indicating the concatenation and a symbol representing empty.

14. The method according to claim 11, wherein said regular expression, represented by said syntax tree, is described by part or all of a character, a metacharacter indicating the selection, a metacharacter indicating a zero time of match or only one time of match, a metacharacter indicating one or more times of match, a metacharacter indicating a zero time of match or indicating one or more times of match, and a symbol indicating the concatenation.

15. A computer-readable recording medium storing a program that causes a computer to execute the following processing comprising:
performing initial setting of an non-deterministic finite automaton to be generated; and
directly generating a non-deterministic finite automaton not including ε-transition based on a regular expression represented by a syntax tree.

16. The computer-readable recording medium according claim 15, storing a program that causes the computer to execute the following processing comprising,
in generating an non-deterministic finite automaton not including ε-transition,
converting the regular expression represented by a syntax tree into a non-deterministic finite automaton not including ε-transition depending on the type of each node of the regular expression represented by said syntax tree;
said non-deterministic finite automaton having a data structure including:
a state of a source of transition;
a state of a destination of transition; and
a condition for transition.

17. The computer-readable recording medium according claim 15, storing a program causing the computer to execute the following processing comprising:
storing a regular expression as a syntax tree that uses a character, a predetermined metacharacter and a symbol in a storage medium;
in performing the initial setting, performing initial setting of an non-deterministic finite automaton depending on the type of a root node of said syntax tree stored in said storage medium;
in generating an non-deterministic finite automaton not including ε-transition, directly converting each node of said syntax tree into said non-deterministic finite automaton not including ε-transition; and
storing said non-deterministic finite automaton which is being converted or which has been converted in said storage medium.

18. The computer-readable recording medium according claim 15, storing a program causing the computer to execute the following processing comprising:
converting a regular expression into a syntax tree that uses a character, a predetermined metacharacter and a symbol;
storing the resulting syntax tree in a storage medium;
in performing the initial setting, performing initial setting of an non-deterministic finite automaton depending on the type of a root node of said syntax tree stored;
in generating an non-deterministic finite automaton not including ε-transition, directly converting each node of said syntax tree into said non-deterministic finite automaton not including ε-transition; and
storing said non-deterministic finite automaton which is being converted or which has been converted in said storage medium.

19. The computer-readable recording medium according claim 17, storing a program causing the computer to execute the following processing comprising:
referencing to said syntax tree and a non-deterministic finite automaton, stored in said storage means;
applying a conversion pattern for conversion into a non-deterministic finite automaton not including ε-transition to each node of said syntax tree to effect conversion thereof to a non-deterministic finite automaton not including ε-transition; and
causing the non-deterministic finite automaton generated to be stored in said storage medium and outputting the non-deterministic finite automaton generated.

20. The computer-readable recording medium according to claim 17, wherein said regular expression, represented by said syntax tree, is described by part or all of a character, a metacharacter indicating the selection, a metacharacter indicating a zero time of match or indicating one or more times of match, a symbol indicating the concatenation and a symbol representing empty.

21. (canceled)
